(19) United States
(12) Patent Application Publication
(10) Pub. No.: US 2013/0270935 A1
(43) Pub. Date: Oct. 17, 2013

(54) FORCE MODULATOR

(71) Applicants: Yen-Wei Hsu, Taipei (TW); Whei-Chyou Wu, Fremont, CA (US)

(72) Inventors: Yen-Wei Hsu, Taipei (TW); Whei-Chyou Wu, Fremont, CA (US)

(21) Appl. No.: 13/447,299

(22) Filed: Apr. 16, 2012

(51) Int. Cl. H02K 9/00; H02K 15/02

(52) U.S. Cl. 310/52; 29/596

(57) ABSTRACT

This invention relates to an inductor, more particularly, to an inductor with variable inductances.

### FIELD OF INVENTION

This invention relates to an electric Switched Reluctance Motor, an air motor, and a force modulator based on the electric Switched Reluctance Motor.

### BACKGROUND INFORMATION

FIG. 5a has shown a diagram of torque (T) versus speed (ω) of a typical electric Switched Reluctance Motor. The diagram of FIG. 5a can be simply devided into three regions, a low speed region presenting constant torque, a constant power region at higher speed of which torque is inversely proportional to speed, and a region with speed higher than the constant power region of which torque is inversely proportional to the square of speed. According to the torque-speed diagram of FIG. 5a, torque decreases when speed increases and torque deteriorates very much when speed gets higher. Obviously, output torque can not satisfy a dynamic loading and decreases at higher speed. Those drawbacks limit the practicability of the electric Switched Reluctance Motor.

When pneumatic motor such as air motor compared with electric motor, pneumatic motor has a higher power/weight ratio (for the same output, the weight is about one-third). Air motor can be installed indefinitely and start immediately with maximum torque. They can be designed to produce equal power in either direction of rotation. They can operate at any speed throughout their design range. They are easily geared to produce maximum power at any required shaft speed. They can be run from any available compressed gas, for example, from natural or a process gas. They can be run at any attitude.

The conventional electric Switched Reluctance Motor has featured no wiring on its rotor for simpler structure. A pneumatic mechanism can be implemented into a conventional electric Switched Reluctance Motor to remedy those drawbacks and the simpler structure of the Switched Reluctance Motor featuring no wiring on its rotor makes the pneumatic implementation possible and easier. Air can also be used to carry away the heat in electric Switched Reluctance Motor. More detailed about the pneumatic implementation into the conventional electric Switched Reluctance Motor will be revealed in the section of the detailed description of the invention. For the purpose of convenience, electric Switched Reluctance Motor can also be called SRM in short in the present invention.

### SUMMARY OF THE INVENTION

The invention has provided a conventional electric Switched Reluctance Motor having curved stream-line poles of the rotor, which has featured a ring by ring excitation control and makes a single phase Switched Reluctance Motor easy and possible.

The invention has provided a force modulator by implementing an air mechanism with an electric Switched Reluctance Motor having conventional straight rotor poles or curved stream-line rotor poles. The rotor of the electric Switched Reluctance Motor of the force modulator rotates driven by electrical power and air. And, the force modulator having curved stream-line rotor poles and having no electrical power driving can be viewed as an inventive air motor. The force modulator having curved stream-line rotor poles can output torque force and an accelerated air flow.

The invention has also provided a method and procedure to form a salient cylinder and air passageways with the stator of the electric Switched Reluctance Motor which can be based in the inventive force modulator or the inventive air motor.

The invention has also provided a force modulator assembly formed by a plurality of force modulators respectively having curved stream-line rotor poles. The plurality of force modulators of the force modulator assembly have a common shaft and in air-in-air-out serial connection and in different rotor sizes from each other for producing different torgues and rotating speed on the common shaft.

### BRIEF DESCRIPTION OF THE DRAWINGS

FIG. 1a has shown a top view of a first type SRM;

FIG. 1b has shown a top view of a rotor of the first type SRM of FIG. 1a;

FIG. 1c has shown a 3-dimension front view of the rotor of FIG. 1b;

FIG. 1d has shown a top view of a stator of the first type SRM of FIG. 1a;

FIG. 1e has shown a front view of a pole of the stator of FIG. 1d;

FIG. 1f has shown the cylindrical stator of FIG. 1d expanded into a plane and a plurality of salients;

FIG. 1g has shown a 3-dimension front view of the stator of FIG. 1d;

FIG. 1h has shown the first type SRM of FIG. 1a viewed from different angle;

FIG. 1i has shown a plurality of salients of the stator of FIG. 1f respectively wound by coil.

FIG. 2a has shown a top view of a second type SRM;

FIG. 2b has shown a top view of a stator of the second type SRM of FIG. 2a;

FIG. 2c has shown a 3-dimension front view of the stator of FIG. 2b;

FIG. 2d has shown the cylindrical stator of FIG. 2b expanded into a plane;

FIG. 2e has shown a top view of a rotor of the second type SRM of FIG. 2a;

FIG. 2f has shown a front view of a straight pole of the rotor of FIG. 2e;

FIG. 2g has shown the cylindrical rotor of FIG. 2e expanded into a plane;

FIG. 2h has shown a 3-dimension front view of the rotor of FIG. 2e;

FIG. 2i has shown the second type SRM of FIG. 2a viewed from different angle with a broken window of the rotor;

FIG. 3a has shown a top view of the first type SRM of FIG. 1a having a salient cylinder;

FIG. 3b has shown an embodiment by implementing a first air-in passageway and an air-out passageway into the SRM of FIG. 3a;

FIG. 3c has shown an embodiment by implementing a first air-in passageway, a second air-in passageway, and an air-out passageway into the SRM of FIG. 3a;

FIG. 3d has shown a 3-dimension front view of the SRM of FIG. 3c;

FIG. 3e has shown an embodiment of a first type SRM in top view implemented with a first air-in passageway, a second air-in passageway, and an air-out passageway;

FIG. 3f has shown the SRM of FIG. 3e in 3-dimension front view;

FIG. 3g has shown the SRM of FIG. 3f and FIG. 3e viewed from different angle with a broken window on the stator;

FIG. 3h has shown an embodiment of a first type SRM in top view implemented with a first air-in passageway, a second air-in passageway, and an air-out passageway;

FIG. 3i has shown the SRM of FIG. 3h in 3-dimension front view;

FIG. 3j has shown an embodiment of a first type SRM in top view implemented with a first air-in passageway, a second air-in passageway, and an air-out passageway;

FIG. 3k has shown the SRM of FIG. 3j in 3-dimension front view;

FIG. 3l has shown an embodiment of a first type SRM in top view implemented with a first air-in passageway, a second air-in passageway, and an air-out passageway;

FIG. 3m has shown the SRM of FIG. 3l in 3-dimension side view;

FIG. 3n has shown an embodiment of the first open end and the second open of the “rotor-salient-cylinder space” between the rotor cylinder and the salient cylinder of a first type SRM are respectively covered by an upper lid and a lower lid in side view;

FIG. 3o has shown an embodiment of the first open end and the second open of the “rotor-salient-cylinder space” between the rotor cylinder and the salient cylinder of a first type SRM are respectively covered by an upper lid and a lower lid in side view;

FIG. 3p has shown an embodiment of the first open end and the second open of the “rotor-salient-cylinder space” between the rotor cylinder and the salient cylinder of a first type SRM are respectively covered by an upper lid and a lower lid in side view;

FIG. 3q has shown a top view of the SRM of FIG. 3p;

FIG. 3r has shown a top view of the SRM of FIG. 3o;

FIG. 3s has shown a top view of the SRM of FIG. 3n;

FIG. 3t has shown an embodiment of an air-tight bearing in a gap between the salient cylinder and the pole of the rotor by engraving a lot of slots on the surface facing the salient cylinder of each rotor pole and disposing a cylindrical roller in each slot;

FIG. 3u has shown an embodiment of a slot and a cylindrical roller disposed in the slot in side view;

FIG. 3v has shown the embodiment of FIG. 3u with its cylindrical siding the salient cylinder;

FIG. 3w has shown an embodiment of a cylindrical roller contactly rolling against the salient cylinder in side view;

FIG. 3x has shown a top view of a slot disposed by a cylindrical roller;

FIG. 3y has shown an embodiment demonstrating a compensating air passageway;

FIG. 4a has shown a 3-dimension front view of a rotor of a first type SRM having curved stream-line poles;

FIG. 4b has shown a top view of a first type SRM having the rotor of FIG. 4a;

FIG. 4c has shown a top view of the SRM of FIG. 4b implemented with air passageways;

FIG. 4d has shown a 3-dimension side view of the SRM of FIG. 4c with a broken window of the stator to show a curved stream-line rotor pole;

FIG. 4e has used a plane to explain the relations between the curved stream-line pole of a rotor and a plurality of holes in a row along its axial orientation on the salient cylinder;

FIG. 4f has shown an embodiment of a top view of a single phase first type SRM having four curved stream-line rotor poles;

FIG. 4g has shown a 3-dimension front view of the rotor of the SRM of FIG. 4f;

FIG. 4h has shown a curved stream-line rotor pole viewed from different angle;

FIG. 4i has used a plane to explain the relations between the driving salients and the curved stream-line rotor poles of the 4/4 single phase SRM of FIG. 4f;

FIG. 4j has used a plane to explain the relations between the driving salients and the curved stream-line rotor poles of a 4/3 first type SRM;

FIG. 4k has used a plane to explain the relations between the driving salients and the curved stream-line rotor poles of a 4/5 first type SRM;

FIG. 4l has shown an embodiment of tapered off curved stream-line rotor poles of a first type SRM;

FIG. 4m has shown an embodiment of a tapered off curved stream-line rotor pole of a second type SRM;

FIG. 5a has shown a diagram of torque versus speed of a conventional electric Switched Reluctance Motor;

FIG. 5b has shown an embodiment of a force modulator assembly formed by a plurality of force modulators having a common shaft and the plurality of force modulators are in air-in-air-out serial connection, and the rotor sizes of the plurality of force modulators are different from each other for producing different torques and shaft speeds;

FIG. 5c has shown a top view of a stator of a first type SRM having air passageways and a tube-support device disposed inside the stator;

FIG. 5d has shown a 3-dimension front view of FIG. 5c;

FIG. 5e has shown the forming of the salient cylinder and air passageways in top view after the cutting off procedure of FIG. 5g;

FIG. 5f has shown a 3-dimension front view of FIG. 5e;

FIG. 5g has shown FIG. 5c with a shady area filled by a matter with flowability;

FIG. 5h has shown two hollow tubes;

FIG. 5i has shown two hollow tubes of FIG. 5h in connection;

FIG. 5j has shown the tube-support device of FIG. 5c in 3-dimension front view disposed with the second type tube and the third type tube;

FIG. 5k has shown the tube-support device with the hollow tubes of FIG. 5j disposed into the stator of FIG. 5c;

FIG. 5l has shown the first type tube going through the holes of the stator to either connect the second type hollow tube or all the way through a hole of the tube-support device;

FIG. 5m has shown an embodiment of a force modulator assembly;

FIG. 6a has shown an embodiment of a salient cylinder and air passageways formed with a stator of a second type SRM in 3-dimension front view;

FIG. 6b has shown a top view of FIG. 6a;

FIG. 6c has shown a 3-dimension front view of a tube-support device for second type SRM having a plurality of holes;

FIG. 6d has shown a 3-dimension front view of the stator of FIG. 6a disposed with the first type tube and the second type tube;

FIG. 6e has shown the stator with the first type tube and the second type tube of FIG. 6d disposed into the tube-support device of FIG. 6c in top view and the third type tube going through the holes of the tube-support device to connect the second type tube;

FIG. 6f has shown a top view of the forming of the salient cylinder and the air passageways with the stator after the cuting-off procedure;

FIG. 6g has shown an embodiment of the first open end and the second open end of the “rotor-salient-cylinder space” between the rotor cylinder and the salient cylinder of a second type SRM in side view respectively covered by a first thrust bearing and a second thrust bearing;

FIG. 6h has shown a top view of the embodiment of FIG. 6g;

FIG. 6i has shown an embodiment of the first open end and the second open of the “rotor-salient-cylinder space” between the rotor cylinder and the salient cylinder of a second type SRM in side view respectively covered by a first thrust bearing and a second thrust bearing; and

FIG. 6j has shown a top view of the embodiment of FIG. 6i.

### DETAILED DESCRIPTION OF THE INVENTION

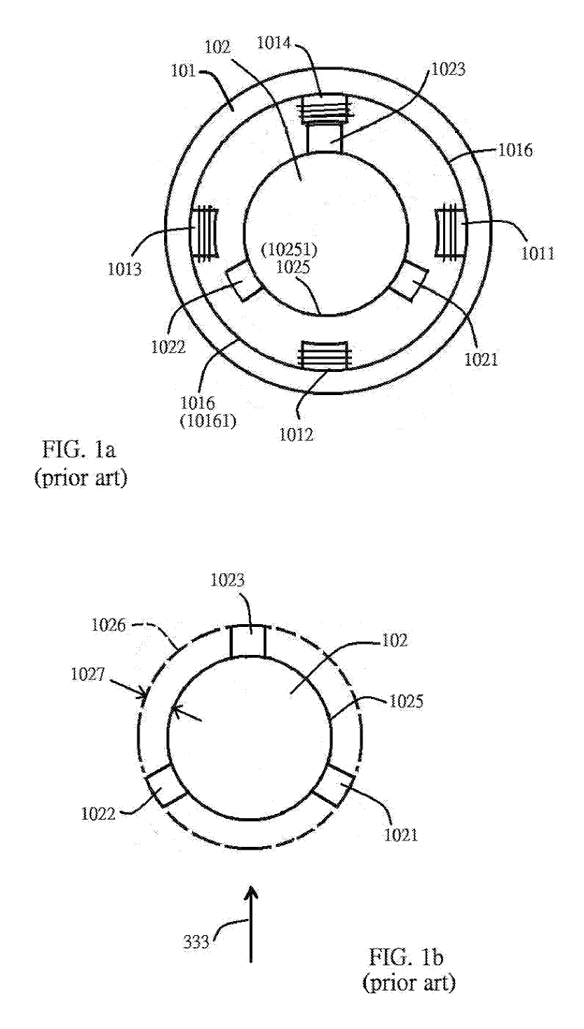

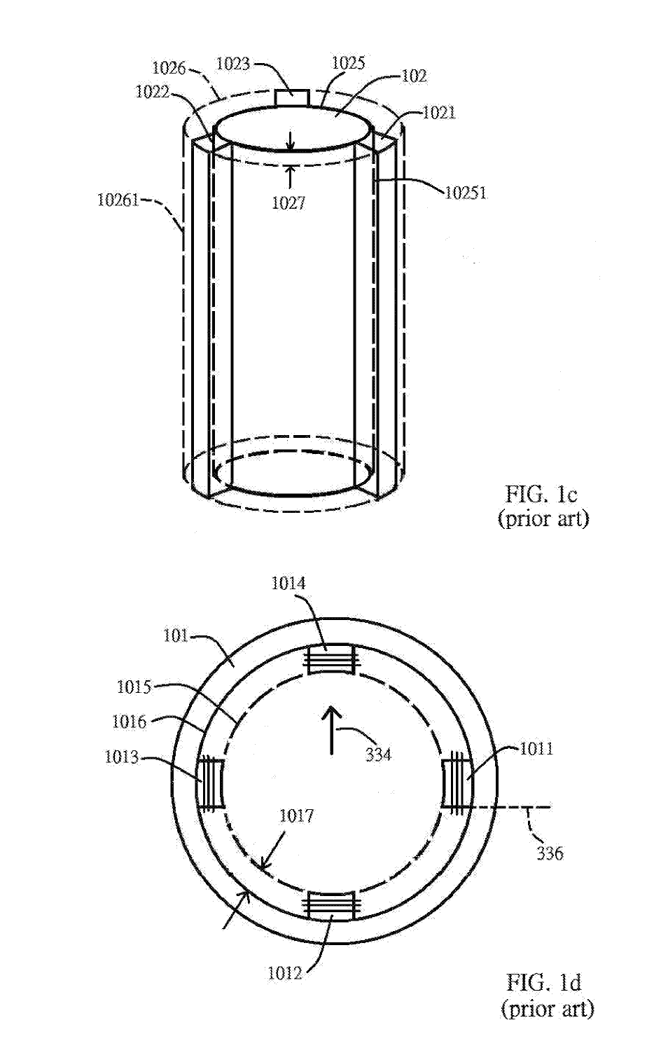

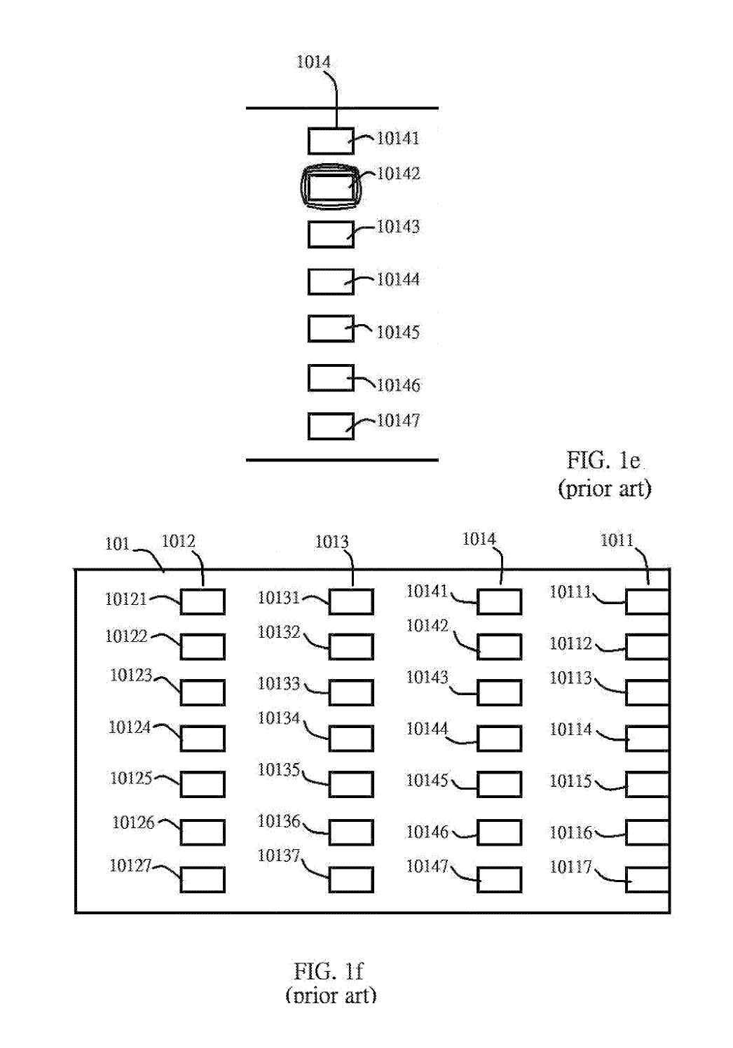

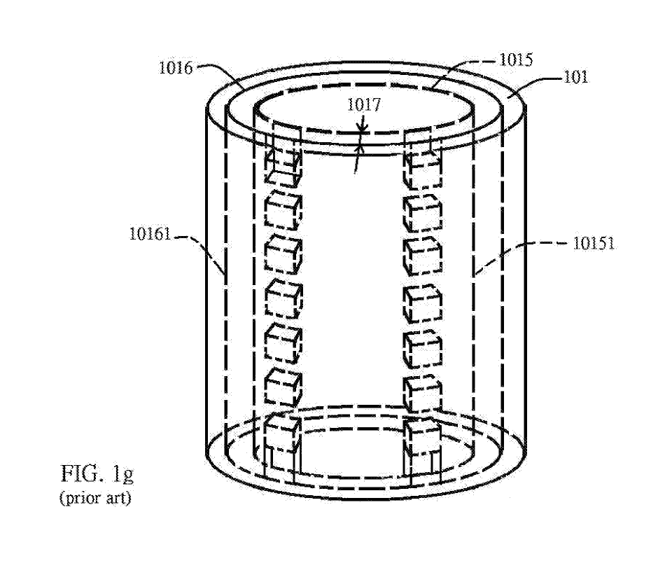

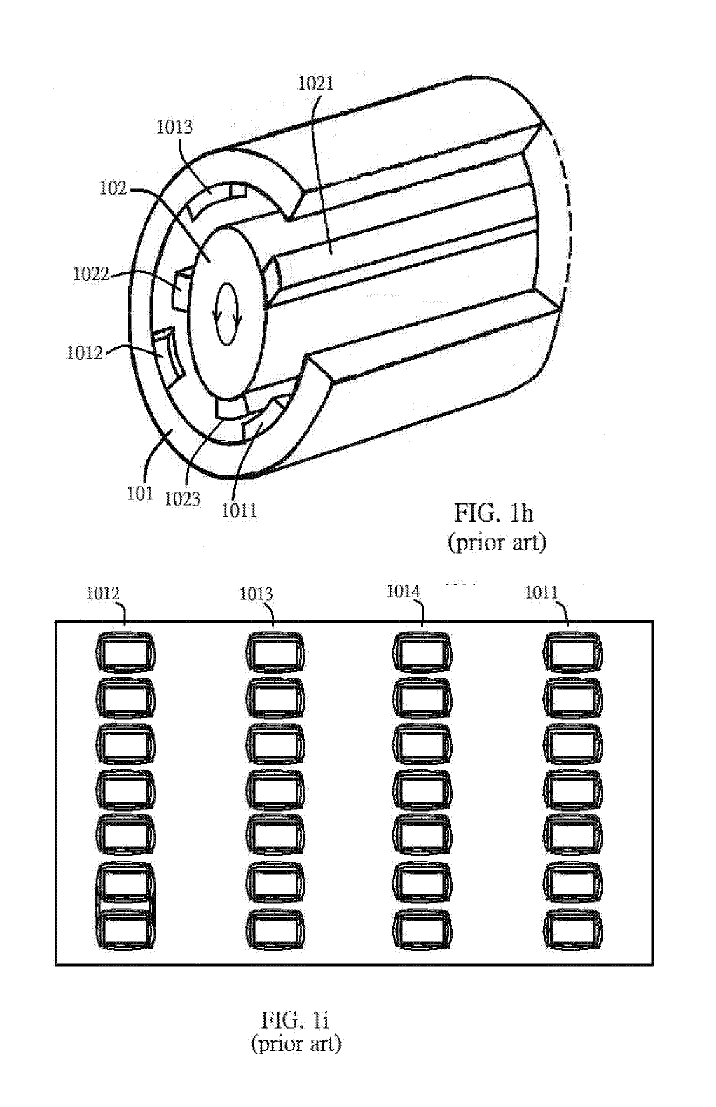

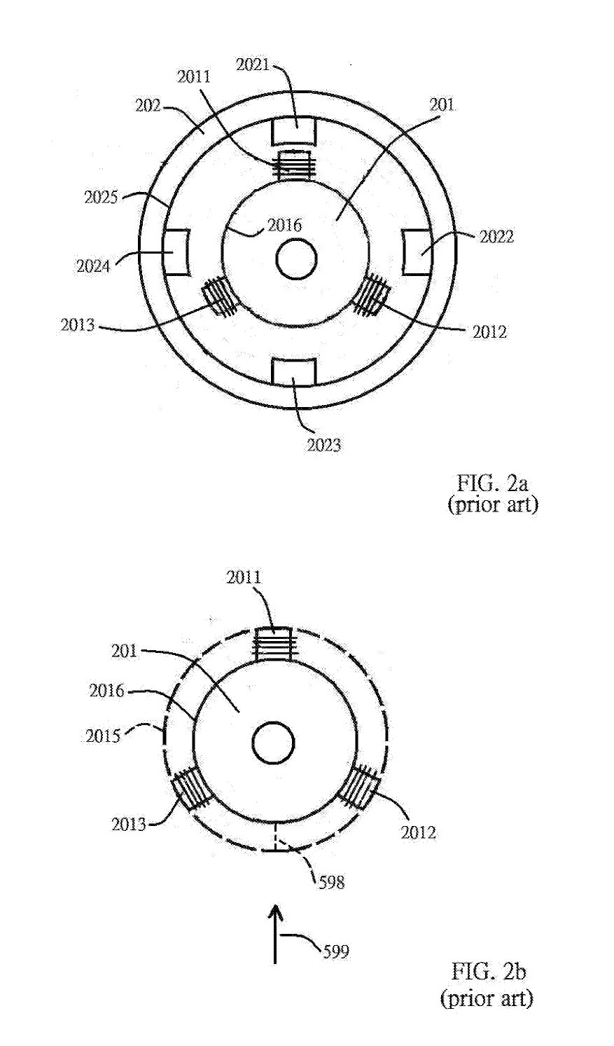

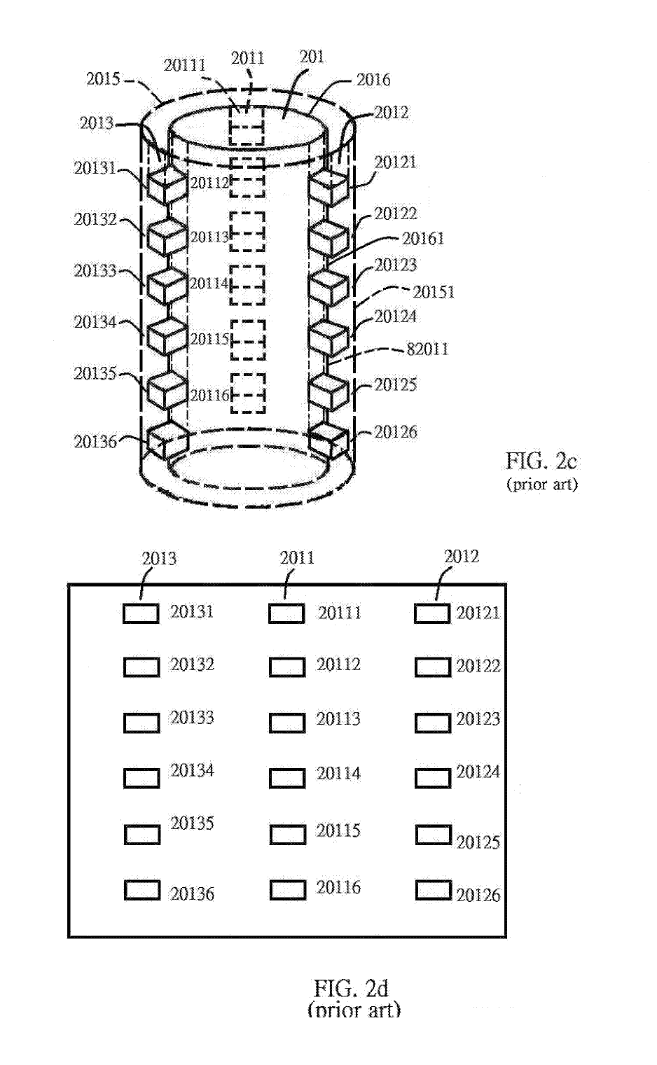

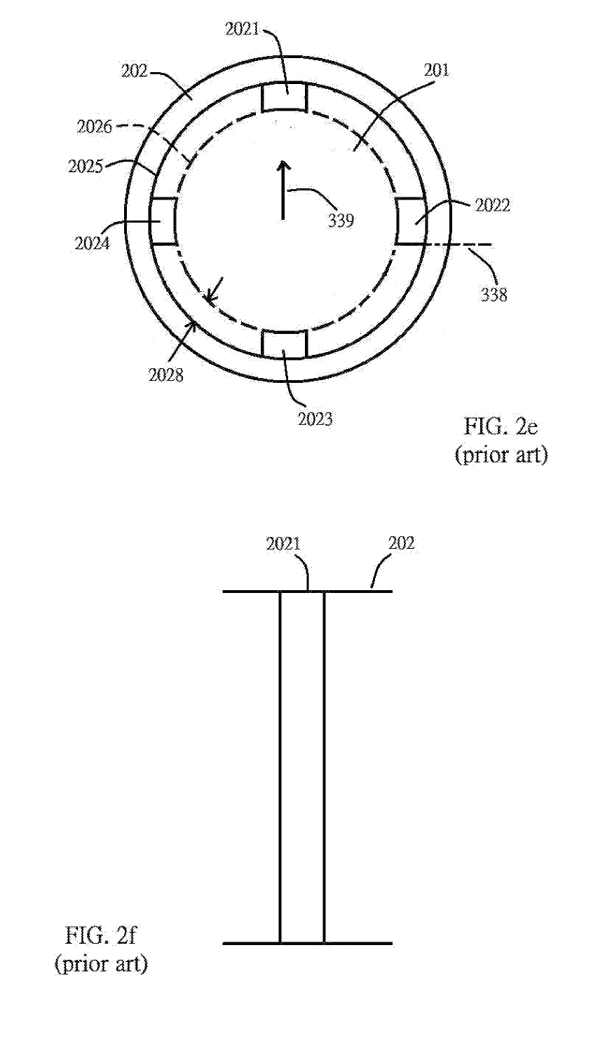

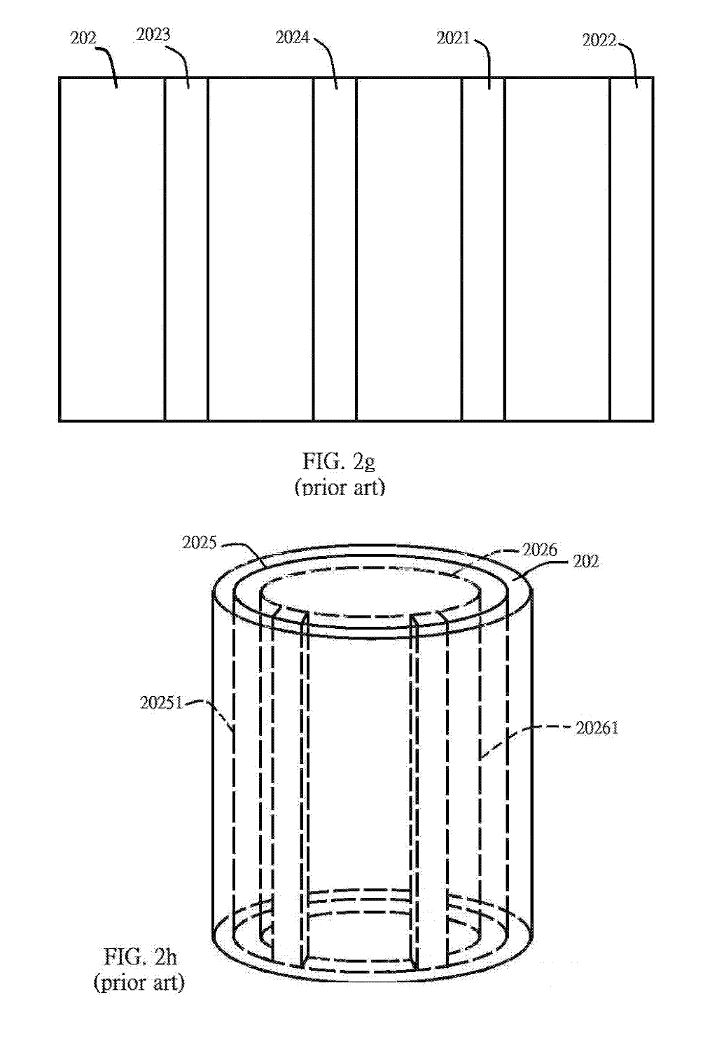

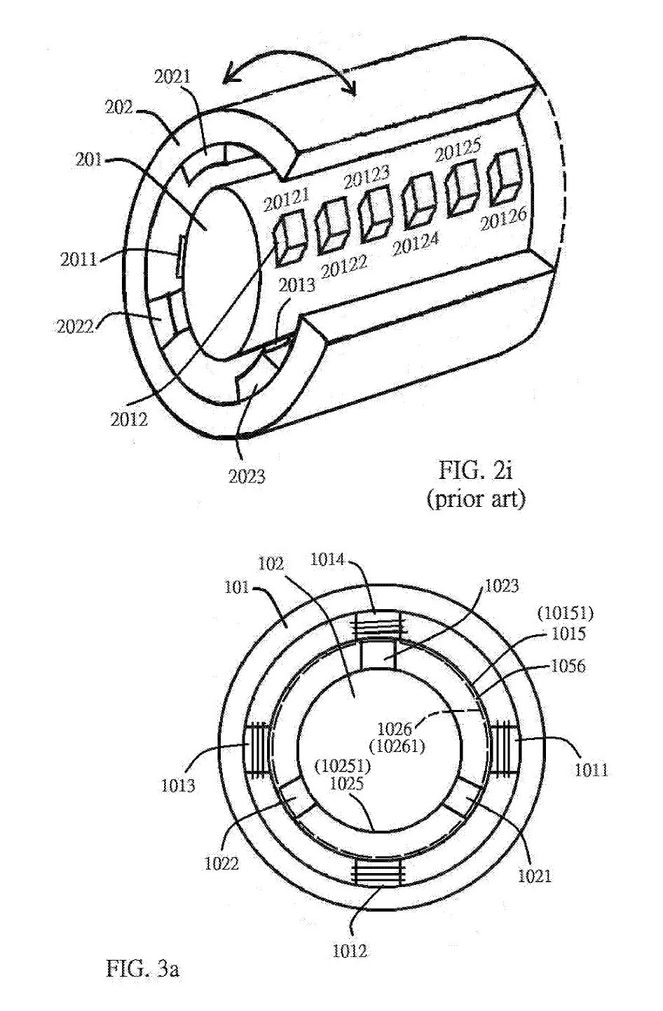

A conventional electric Switched Reluctance Motor is simply introduced. For the purpose of simplification, a simple 4/3 Switched Reluctance Motor is used for introduction. FIG. 1a and FIG. 2a have respectively shown a top view of two different type conventional 4/3 electric Switched Reluctance Motors respectively formed by a stator and a rotor. For the purpose of convenience, electric Switched Reluctance Motor can also be called SRM in short in the present invention. FIG. 1a has shown a SRM with its stator 101 surrounding its rotor 102. FIG. 2a has shown a SRM with its rotor 102 surrounding its stator 101.

For the purpose of convenience, the type of the SRM with its stator surrounding its rotor as shown in FIG. 1a and the type of the SRM with its rotor surrounding its stator as shown in FIG. 2a are respectively called a first type SRM and a second type SRM in the present invention. Both the stator and the rotor of a conventional SRM respectively have a plurality of straight poles and each pole of the stator has a plurality of salients wound by coil for magnetization.

The rotor 102 of the first type SRM of FIG. 1a has a first rotor pole 1021, a second rotor pole 1022, and a third rotor pole 1023. The stator 101 of the SRM of FIG. 1a has a first stator pole 1011, a second stator pole 1012, a third stator pole 1013, and a fourth stator pole 1014. Each of the first stator pole 1011, second stator pole 1012, third stator pole 1013, and fourth stator pole 1014 has a plurality of salients in a row.

Switched Reluctance Motor has featured no wiring on its rotor such that, for the purpose of convenience, a part having wires on its poles in the drawing indicates the part is a stator, for example, the part having wires 149 on its poles 1011, 1012, 1013, and 1014 is the stator 101 shown in FIG. 1a.

FIG. 1b has shown a top view of the rotor 102 of the first type SRM of FIG. 1a and FIG. 1c has shown a 3-dimension front view of the rotor 102 of FIG. 1b with a viewing in angle shown by an arrow 333 shown in FIG. 1b.

The rotor 102 has a rotor cylinder 10251 and a rotor-rotation cylinder 10261 depicted by the rotation of the rotor poles seen in FIG. 1c. A top view of the rotor cylinder 10251 and the rotor-rotation cylinder 10261 are respectively a circle 1025 and a circle 1026 seen in both of FIG. 1b and FIG. 1c. The rotor-rotation cylinder 10261 formed by the rotation of the rotor poles is expressed by a dotted line.

FIG. 1d has shown a top view of the stator 101 of the first type SRM of FIG. 1a and a 3-dimension front view of a portion of the stator 101 of FIG. 1d is shown in FIG. 1g. The stator 101 has a stator cylinder 10161 seen in FIG. 1g and a top view of the stator cylinder 10161 is a circle which can be seen in the top view of the stator of FIG. 1d.

The surfaces facing the rotor 102 of the plurality of salients can form a cylinder, for the purpose of convenience, the cylinder is called “salient cylinder” in the present invention. Obviously, the surfaces facing the rotor of all the salients are on the salient cylinder. The salient cylinder 10151 is marked by a dotted line shown in FIG. 1g. A top view of the salient cylinder is a circle 1015 seen in FIG. 1d. The heights respectively of the “salient cylinder” 10151 and the “stator cylinder” 10161 can be same or different.

For the purpose of conveneince, a space between the stator cylinder 10161 and the salient cylinder 10151 is called “stator-salient-cylinder space” in the present invention. A space between the “rotor inner cylinder” 10251 and the salient cylinder 10151 is called “rotor-salient-cylinder space” in the present invention.

A plurality of salients of a salient pole is introduced in FIG. 1e. FIG. 1e has shown a front view of the fourth stator pole 1014 of the stator 101 of the first type SRM of FIG. 1d with its viewing in orientation indicated by an arrow 334 of which a plurality of salients 10141, 10142, 10143, 10144, 10145, 10146, and 10147 in a row are seen.

FIG. 1f has shown the stator 101 expanded into a rectangle by cutting the stator 101 along a cross-section cutting line 336 shown in FIG. 1d for providing global view on the stator poles and the salients. FIG. 1f has shown each salient pole having a plurality of salients wound by coil for magnetization. FIG. 1f has also shown that the first stator pole 1011 having seven salients 10111, 10112, 10113, 10114, 10115, 10116, and 10117 in a row, the second stator pole 1012 having seven salients 10121, 10122, 10123, 10124, 10125, 10126, and 10127 in a row, the third stator pole 1013 having seven salients 10131, 10132, 10133, 10134, 10135, 10136, and 10137 in a row, and the fourth stator pole 1014 having seven salients 10141, 10142, 10143, 10144, 10145, 10146, and 10147 in a row.

FIG. 1i has shown that the salients of the stator of FIG. 1f are coiled.

FIG. 1h has shown the first type SRM of FIG. 1a with a broken window on the stator 101 seen from different viewing angle.

FIG. 2k has shown a 3-dimension front view of the second type SRM of FIG. 2a with a cylinder 8031 depicted by the rotation of the rotor for providing more overall observation.

FIG. 2a has shown a top view of the second type SRM. The rotor 202 of the second type SRM shown in FIG. 2a has a first rotor pole 2021, a second rotor pole 2022, a third rotor pole 2023, and a fourth rotor pole 2024. The stator 201 of the second type SRM of FIG. 2a has a first stator pole 2011, a second stator pole 2012, and a third stator pole 2013 and each of the first stator pole 2011, the second stator pole 2012, and the third stator pole 1013 has a plurality of salients respectively wound by coil for magnization.

FIG. 2b has shown a top view of the stator 201 of the second type SRM shown in FIG. 2a.

FIG. 2c has shown a 3-dimension front view of the stator 201 with its viewing orientation indicated by an arrow 599 shown in FIG. 2b. FIG. 2c has also shown a salient cylinder 20151, a stator cylinder 20161, and each stator pole has a plurality of salients. A top view of the salient cylinder 20151 and the stator cylinder 20161 are respectively a circle 2015 and a circle 2016 shown in the top view of the stator of FIG. 2b.

FIG. 2d has shown the stator 201 expanded into a rectangle by cutting the stator 201 along a cross-section cutting line 598 shown in FIG. 2b for providing more global view on the stator poles and the salients.

FIG. 2j has shown the plurality of salients of FIG. 2d coiled for magnetization.

FIG. 2e has shown a top view of the rotor 202 of the second type SRM of FIG. 2a and FIG. 2h has shown a 3-dimension front view of the rotor 202 of FIG. 2e. FIG. 2h has shown a rotor cylinder 20251 and a rotor-rotation cylinder 20261 marked by a dotted line. A top view of the “rotor-rotation cylinder” 20261 is a circle 2026 and a top view of the rotor cylinder 20251 is a circle 2025 shown in the top view of the rotor 202 of FIG. 2e.

FIG. 2f has shown a front view of the straight first rotor pole 2021 of the rotor 202 of FIG. 2e with a viewing angle shown by an arrow 339.

FIG. 2g has shown the rotor 202 shown in FIG. 2e expanded into a rectangle for providing more global view on the straight rotor poles 2021, 2022, 2023, and 2024 by cutting the rotor 202 along a cross-section cutting line 338 shown in FIG. 2e.

FIG. 2i has shown the second type SRM of FIG. 2a with a boken window on the rotor 202 seen from different viewing angle for reference.

A gap 1056 exists between the salient cylinder 10151 and the rotor-rotation cylinder 10261.

The stator has a first open end and the rotor has a second end.

A “rotor-salient-cylinder space” is a space between the “rotor cylinder” 10251 and the salient cylinder 10151. Obviously, the “rotor-salient-cylinder space” has a first open end and a second open end.

A chamber is a space between two neighboring poles of the rotor in the “rotor-salient-cylinder space” with its first open end and second open end respectively covered by a first lid and a second lid so that a plurality of chambers are formed in the “rotor-salient-cylinder space”. The first lid and the second lid will be discussed later in the present invention.

Each chamber should be as air-tight as possible. Air in a chamber can leak to a neighboring chamber through a tiny gap 1056 between the salient cylinder 10151 and the pole of the rotor so that an air-tight bearing should be disposed between the stationary salient cylinder of the stator and the rotating poles of the rotor. The air-tight bearing should also be a good lubricant between the stationary salient cylinder of the stator and the rotating poles of the rotor.

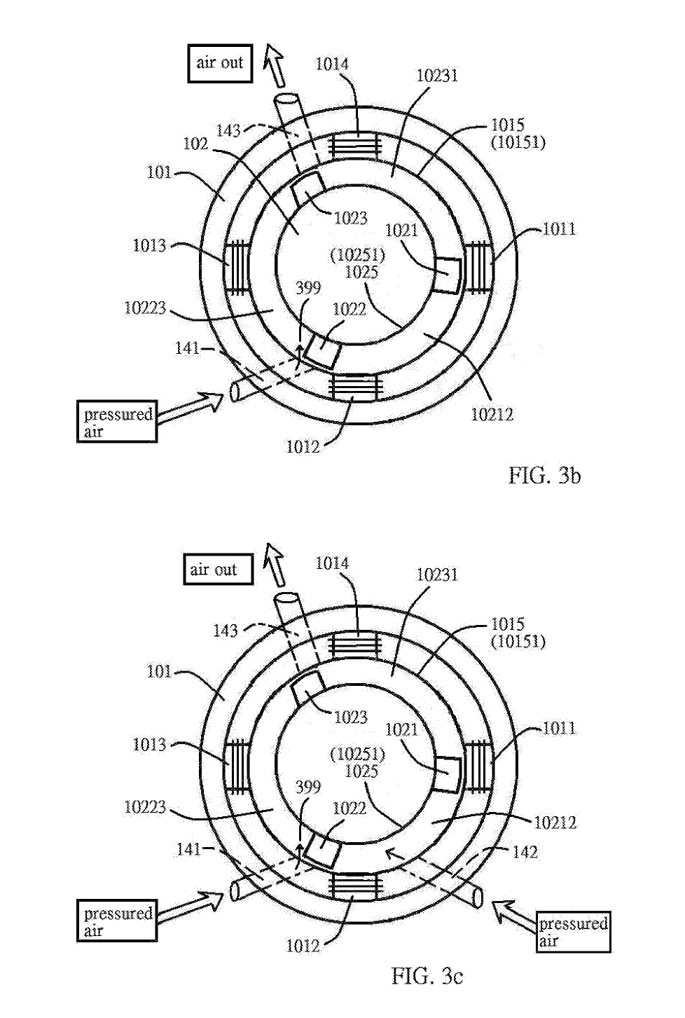

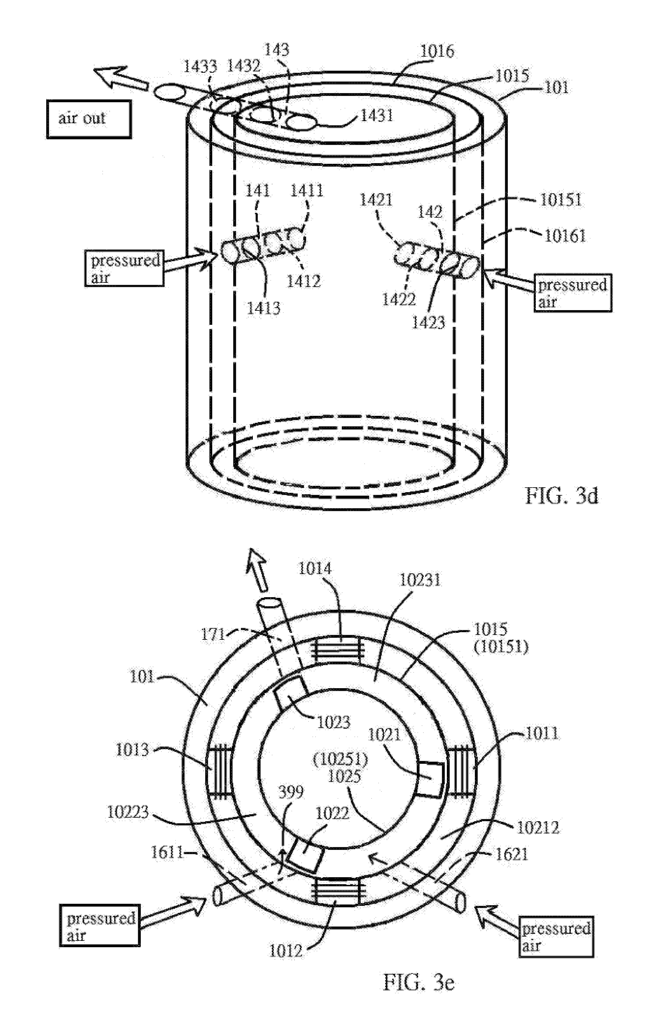

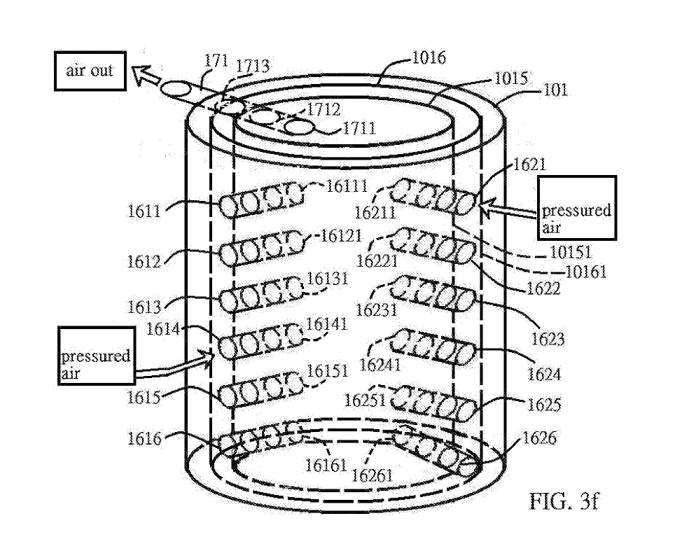

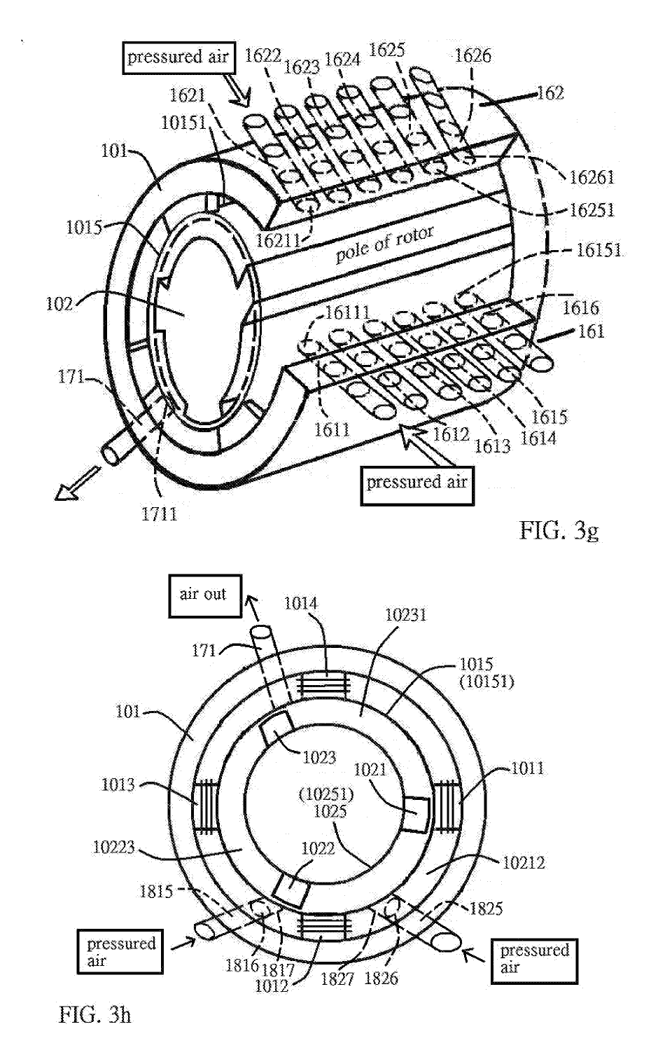

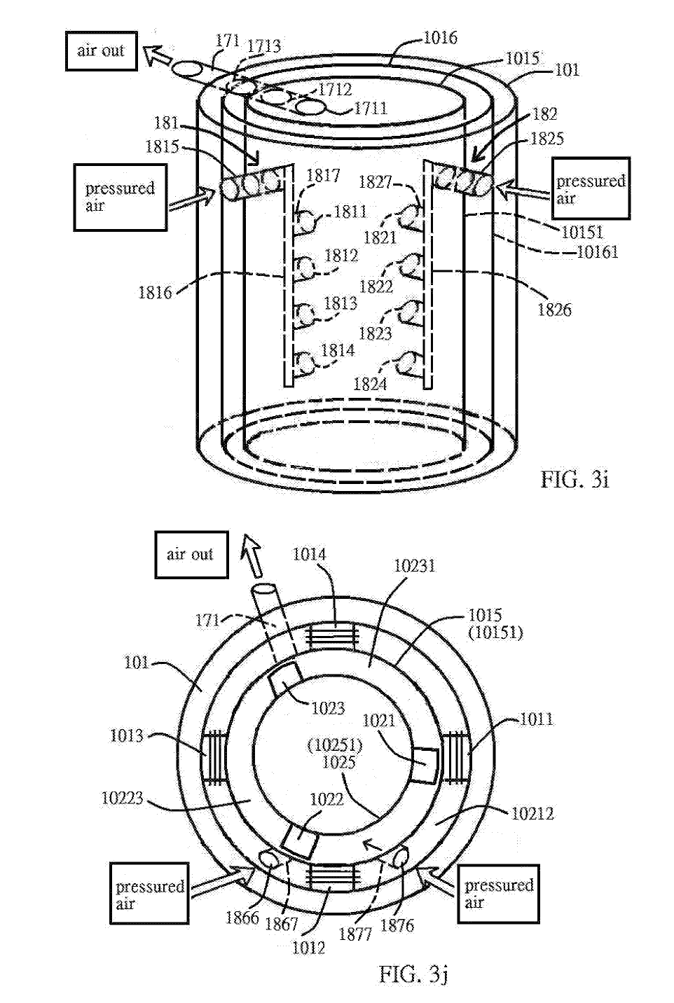

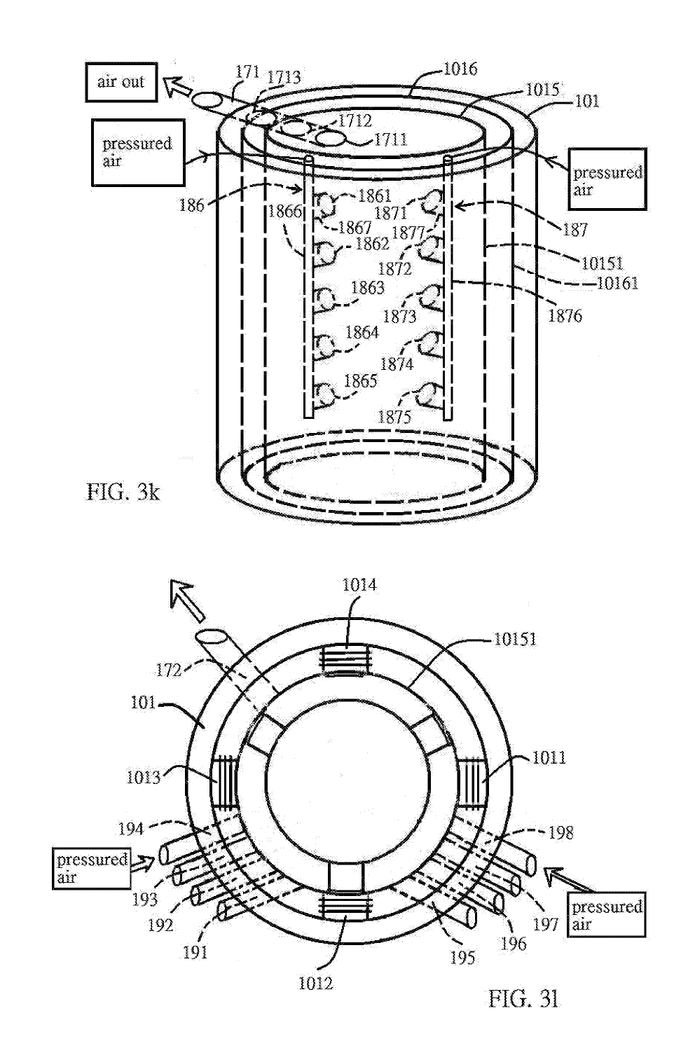

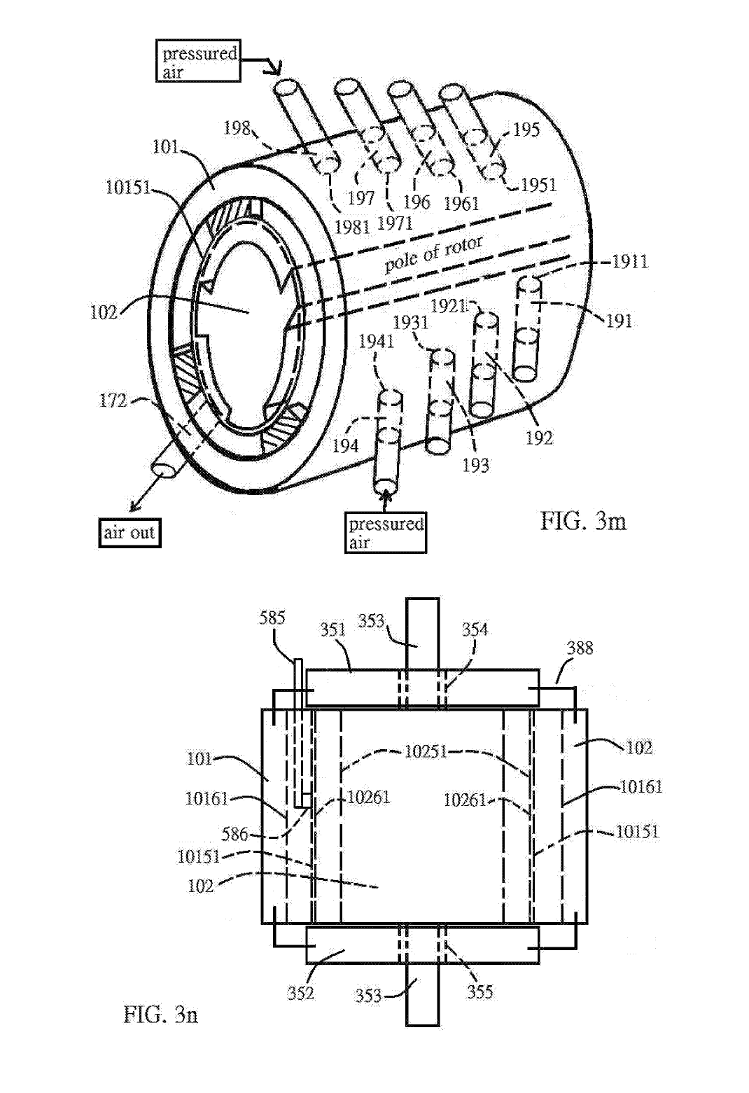

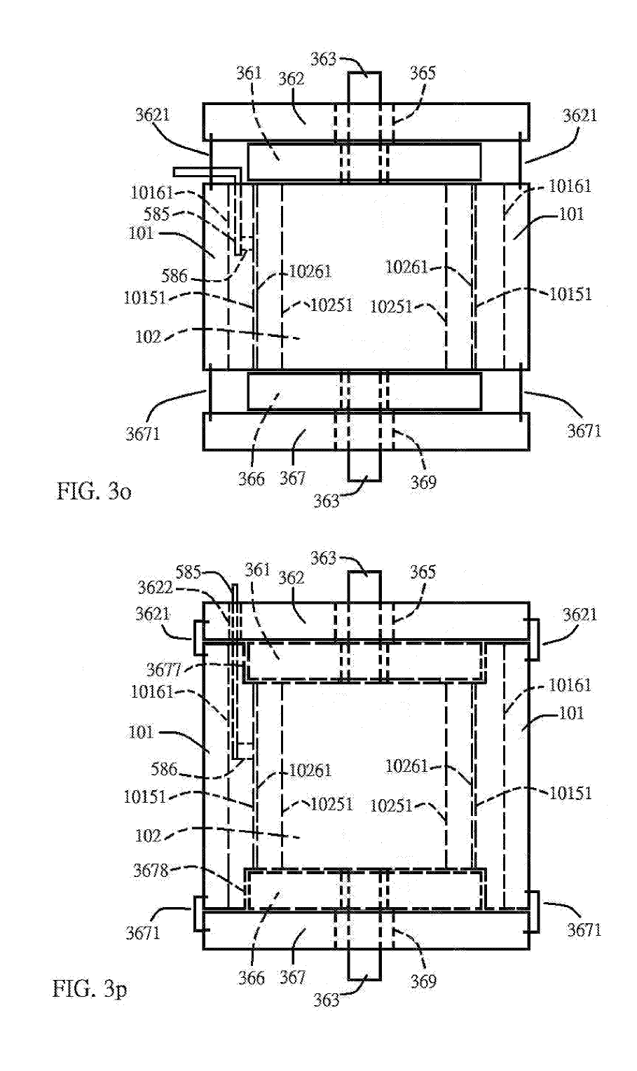

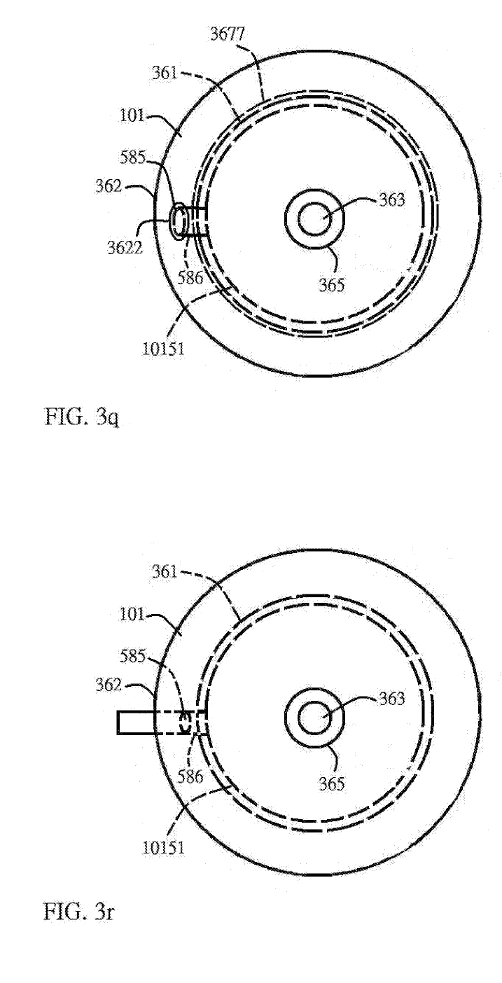

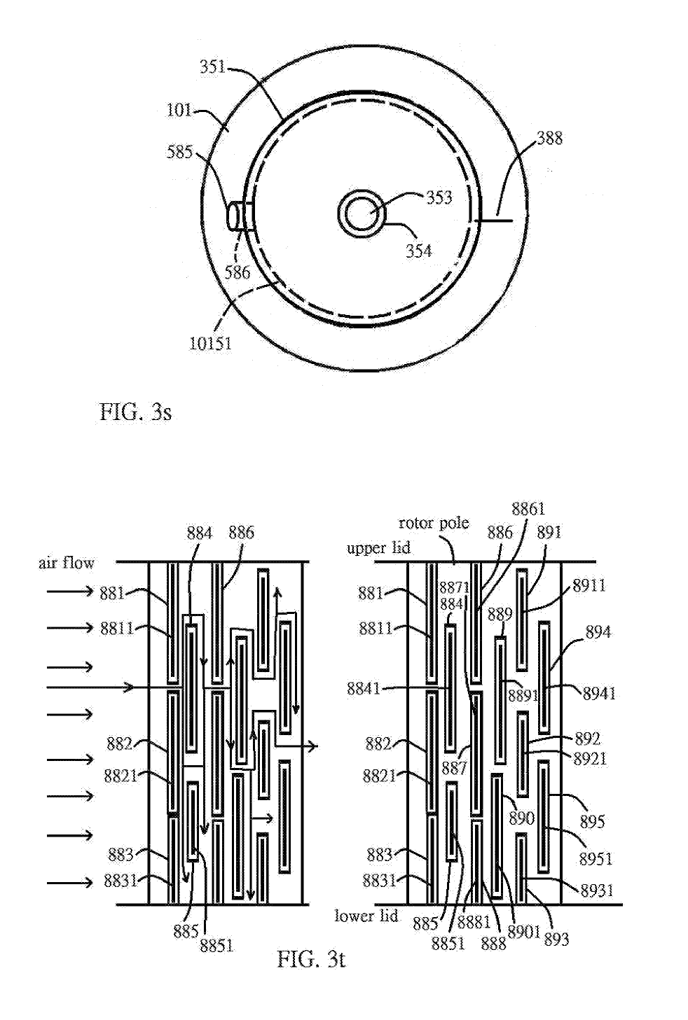

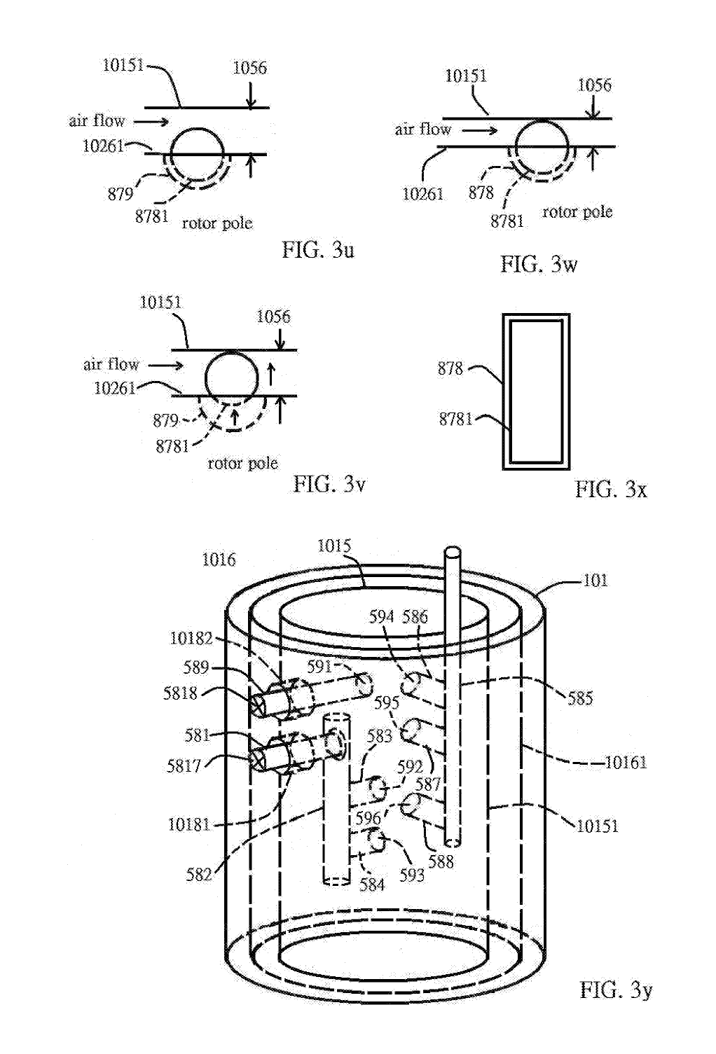

An embodiment, the air-tight bearing can be formed by a plurality of slots engraved on the surface of each rotor pole and a plurality of cylindrical rollers with one cylindrical roller disposed in each slot. The embodiment of the air-tight bearing will be discussed later accompanying with FIG. 3t, FIG. 3u, FIG. 3v, FIG. 3w, and FIG. 3x.

Air passageway is for air flowing between outside the SRM and the “rotor-salient-cylinder space” through at least a hole opened on the salient cylinder 10151. An air passageway has at least a hole opened on a salient cylinder of a SRM and at least an opening outside the SRM so that either air can flow into the opening outside the SRM, through the air passageway, and the hole opened on the salient cylinder into the “rotor-salient-cylinder space” or air inside the “rotor-salient-cylinder space” flows through the hole opened on the salient cylinder, through the air passageway, and the opening to outside the SRM.

For the purpose of conveneince, an air passageway for air inside “rotor-salient-cylinder space” of the SRM flowing out of the SRM is called “air-out passageway” in the present invention and an air passageway for air outside the SRM flowing into the “rotor-salient-cylinder space” of the SRM is called “air-in passageway” in the present invention.

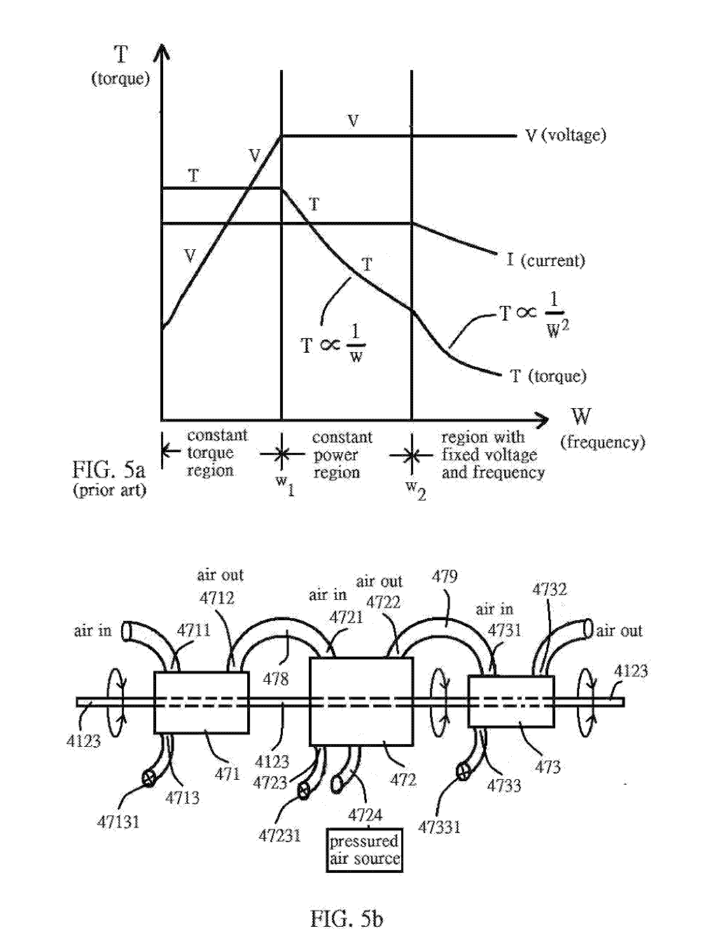

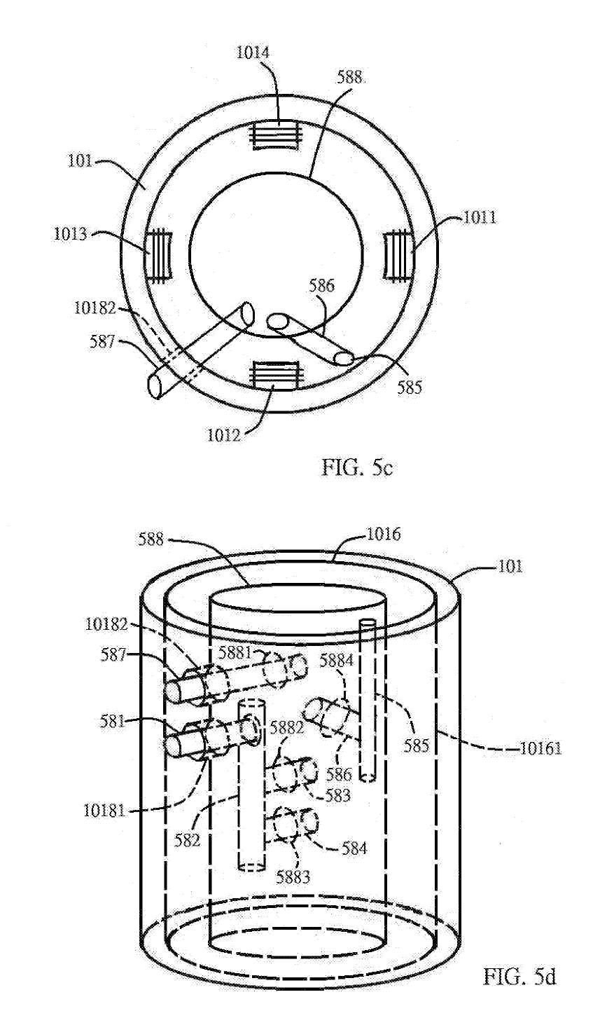

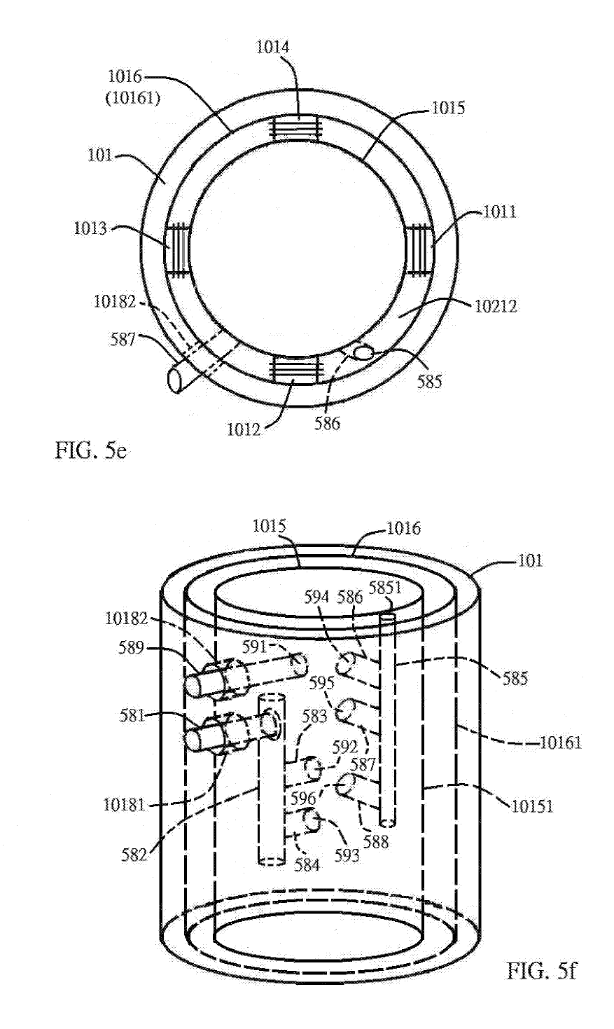

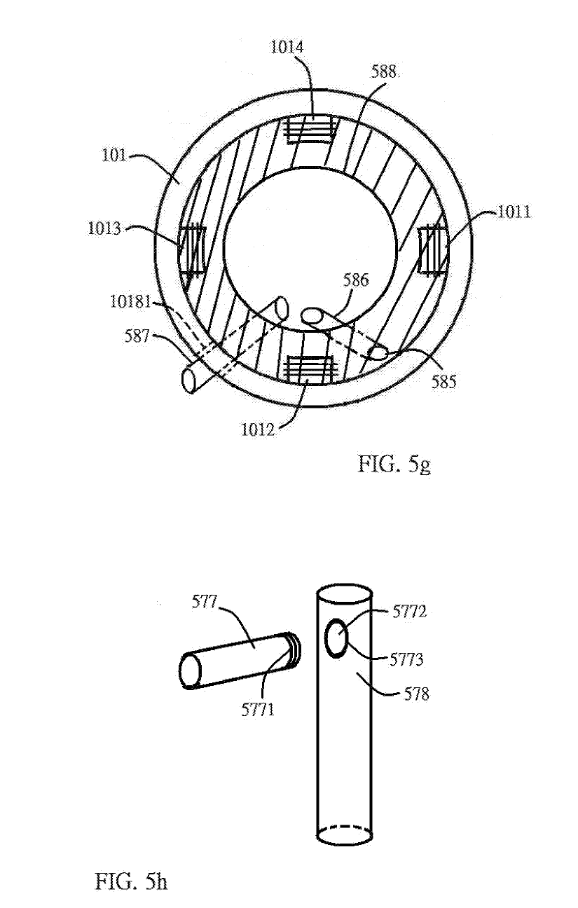

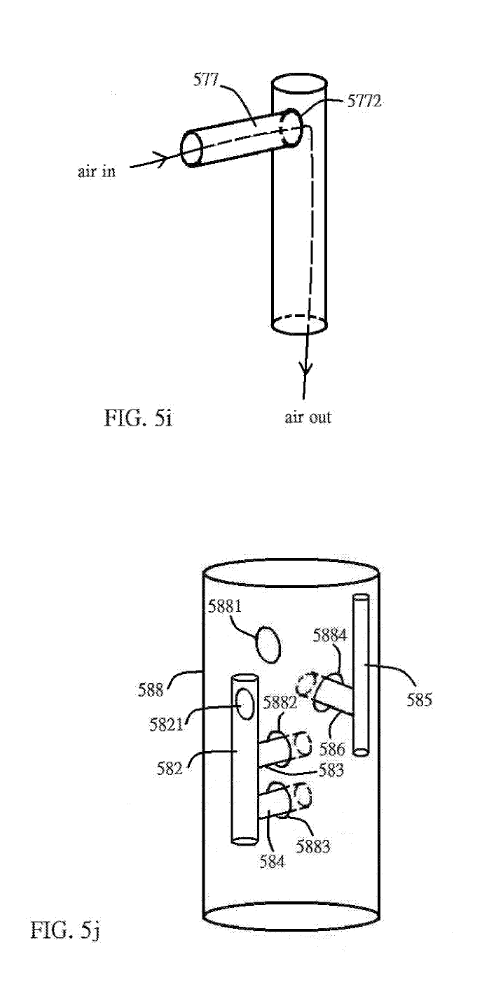

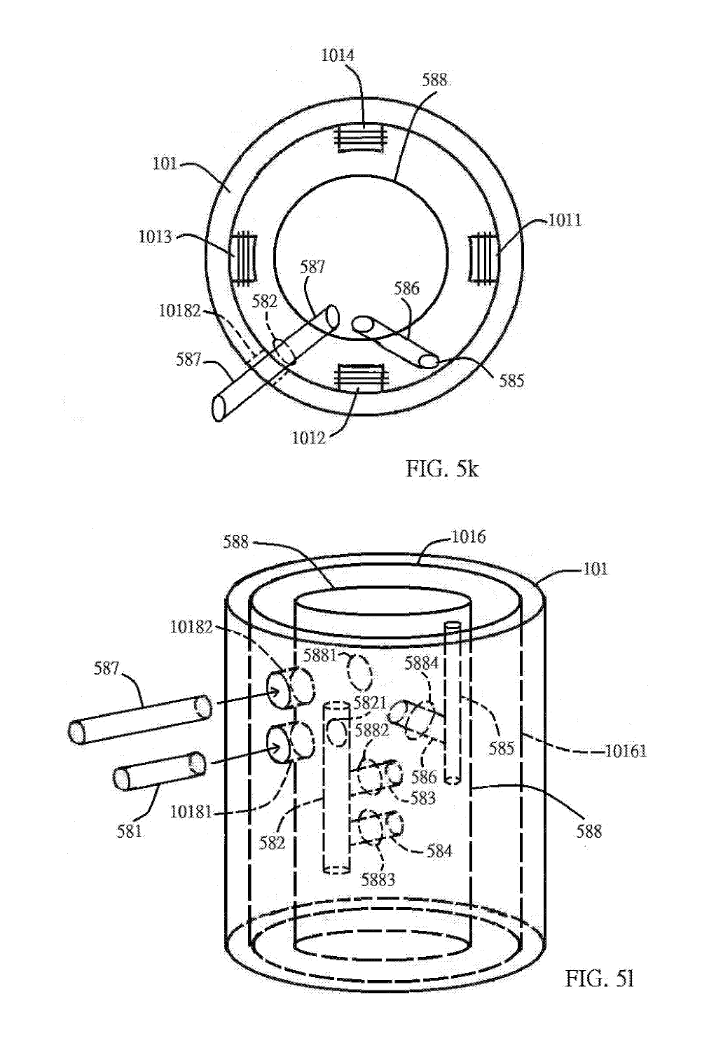

Before going further, FIG. 5h has shown an embodiment explaining a connection between two hollow tubes. FIG. 5h has shown a first hollow tube 577 having a first connector 5771 and a second hollow tube 578 having an opening 5781 of which a second connector 5782 is built. Air can flow through the two hollow tubes 577 and 578 with the connection of the first connector 5771 and the second connector 5782 as shown in FIG. 5i. The first connector 5771 and the second connector 5782 are not limited, for example, an embodiment, any one of the first connector 5771 and the second connector 5782 is a male screwing type connector and the other one is a female screwing type connector.

An embodiment, FIG. 5e and FIG. 5f have respectively shown the top view of the stator 101 of the first type SRM and a 3-dimension front view of the stator 101 of FIG. 5e without showing the salients for the purpose of simplifying the drawing. FIG. 5e and FIG. 5f have also respectively shown the stator 101 having a plurality of stator holes 10181 and 10182 therethrough, a plurality of hollow tubes 581, 582, 583, 584, 585, 586, 587, 588, and 589, and a salient cylinder 10151. A third hollow tube 583, a fourth hollow tube 584, a sixth hollow tube 586, a seventh hollow tube 587, an eighth hollow tube 588, and a nineth hollow tube 589 respectively has a second hole 592, a third hole 593, a fourth hole 594, a fifth 595, a sixth hole 596, and a first hole 591 opened on the salient cylinder 10151.

A first hollow tube 581 goes through a first stator hole 10181 to connect a second hollow tube 582 that also connects the third hollow tube 583 and the fourth hollow tube 584. The fifth hollow tube 585 and the second hollow tube 582 are respectively disposed in the space between the stator cylinder 10161 and the salient cylinder 10151. The fifth hollow tube 585 connects the sixth hollow tube 586, the seventh hollow tube 587, and the eighth hollow tube 588. The nineth hollow tube 589 goes through a second hole 10182 all the way to the first hole 591 opened on the salient cylinder 10151.

For the purpose of convenience, the hollow tube penetrating the stator 101 such as the first hollow tube 581 and the nineth hollow tube 589, the hollow tube disposed in the space between the stator cylinder 10161 and the salient cylinder 10151 such as the second hollow tube 582 and the fifth hollow tube 585, and the hollow tube connecting the hole opened on the salient cylinder 10151 such as the third hollow tube 583, the fourth hollow tube 584, the sixth hollow tube 586, the seventh hollow tube 587, and the eighth hollow tube 588 are respectively called as a first type tube, a second type tube, and a third type tube in the present invention. Please note that the hollow tube penetrating through the stator 101 and also connecting the hole opened on the salient cylinder 10151 shown as the nineth hollow tube 589 is viewed as the first type tube.

For the purpose of convenience, a first type air passageway is formed by at least one first type tube penetrating through the stator 101 all the way to the hole of the salient cylinder 10151 shown as the nineth hollow tube 589 in FIG. 5f. A second type air passageway is formed by the second type tube connecting at least one first type tube and at least one third type tube shown as the assembly of the hollow tubes 581, 582, 583, and 584 in FIG. 5f. A third type air passageway is formed by the second type tube connecting at least one third type tube shown as the assembly of the hollow tubes 585, 586, 587, and 588 in FIG. 5f. Air into the first type air passageway and the second type air passageway can go through the first type tube penetrating through the stator 101 and the third type air passageway has an air input entrance at the open end of the SRM as shown by the fifth hollow tube 585 in FIG. 5f.

As discussed earlier, an air passageway for air inside “rotor-salient-cylinder space” of the SRM flowing out of the SRM is called “air-out passageway” in the present invention and an air passageway for air outside the SRM flowing into the “rotor-salient-cylinder space” of the SRM is called “air-in passageway” in the present invention.

Both the air-in passageway and air-out passageway in the first type SRM can be the first type air passageway, the second type air passageway, the third type air passageway, or any combinations of them.

The size and the shape of each hollow tube is not limited, for example, each hollow tube can be cylindrical and the size of each hollow tube may be different from each other.

More penetrations through the stator 101 can break the magnetic integrity of the stator 101 resulting in lowering its magnetic efficiency and more penetrations through the stator 101 may also lower the mechanical strength of the stator 101.

If an air pressure outside a SRM higher than an air pressure in a chamber of the SRM, then air outside the SRM will flow through an air-in passageway into the chamber, for example, a higher air pressure source outside a SRM can be a high pressured air tank. A space between the salient cylinder 10151 and the stator cylinder 10161 can be filled by a harden matter to strength the support to the salient cylinder and strength the hold to the air passageways. A method and a procedure to manufacture it will be discussed later.

The function of air passageway is introduced. FIG. 3a has shown a top view of a first type SRM. An embodiment, FIG. 3b has shown the top view of the SRM of FIG. 3a implemented with a first air-in passageway and an air-out passageway. FIG. 3b has shown the first air-in passageway 141 and the air-out passageway 143 respectively formed by a hollow tube penetrating through the stator 101 of the SRM.

A plurality of chambers are formed in the “rotor-salient-cylinder space”, shown in FIG. 3b, a first chamber 10212 is formed between the first rotor pole 1021 and the second rotor pole 1022 in the “rotor-salient-cylinder space”, a second chamber 10223 is formed between the second rotor pole 1022 and the third rotor pole 1023 in the “rotor-salient-cylinder space”, and a third chamber 10231 is formed between the third rotor pole 1023 and the first rotor pole 1021 in the “rotor-salient-cylinder space”.

Air flows through the first air-in passageway 141 into a chamber to push the pole of the rotor 102 to rotate at a first orientation. The orientation of a blowing air out of the first air-in passageway 142 has a component in parallel to that of the rotation of the rotor.

The orientation of a blowing air out of the first air-in passageway 141 trys to be as possible as in parallel to the orientation of the rotation of the rotor to produce the maximun rotating force of the rotor.

An air pressure built in the chamber can be transformed into a force acting on the surface of the rotor pole described by equation PA=F of which P, A, and F are respectively air pressure, surface area of the side of the rotor pole, and force. An air pressure built in a chamber can be viewed as an energy absorption and releasing the air pressure in the chamber can be viewed as energy release and an energy between the energy absorption and the energy release is transformed into a force power.

If air flowing through the first air-in passageway into a chamber is immediately leaked out through the air-out passageway, then a significant air pressure in the chamber can not be obtained and the amount of air consumed will be increased resulting in consuming more energy.

A significant air pressure built in a chamber had better last for a period of time to be transformed into a rotating power before leaking out.

The air flowing through the first air-in passageway into a chamber will be released through the air-out passageway out to restore air pressure difference with air-in pressure before the chamber takes a next air-in through the first air-in passageway 141 for improving efficiency. For example, an embodiment, an air flowing into a chamber through its air-in passageway leads the air leaking out of the chamber through its air-out passageway by 180°.

An embodiment, the first air-in passageway 141 and the air-out passageway 143 are such disposed that each rotating chamber at any time does not bestride both the first air-in passageway 141 and the air-out passageway 143.

As seen in FIG. 3b, air starts to fill in the second chamber 10223 indicated by an arrow 399 when the second rotor pole 1022 counterclockwisely rotates to a location just passing the first air-in passageway 141 and the second chamber 10223 has left the air-out passageway 143 such that the rotating second chamber 10223 has no chance to bestride both the first air-in passageway 141 and the air-out passageway 143. In other words, air flowing through the first air-in passageway into the second chamber 10223 will not be immediately released through the air-out passageway out of the second chamber 10223 and a significant air pressure can be built in the second chamber.

Also, the orientation of a blowing air out of the air-in passageway trys to be as possible as in parallel to the orientation of the rotation of the rotor to produce the maximun rotating force of the pole of the rotor.

The first air-in passageway 141 and the air-out passageway 143 can also be seen in FIG. 3d which is a 3-dimension front view of the SRM of FIG. 3b without showing its rotor and the salients for the purpose of simplifying the drawing.

Seen in FIG. 3d, a plurality of dotted circles 1412 and 1413 of the first air-in passageway 141 express a hole penetrating through the stator 101 and a dotted circle 1411 expresses a hole opened on the salient cylinder 10151. A plurality of dotted circles 1432 and 1433 of the air-out passageway 143 express a hole penetrating through the stator 101 and a dotted circle 1431 expresses a hole opened on the salient cylinder 10151.

If the rotor 102 is allowed to rotate clockwisely or counterclockwisely, then a second air-in passageway to blow the pole of the rotor to rotate at a second orientation, which is opposite to the first orientation, is needed. FIG. 3c has shown a second air-in passageway 142 formed by a second hollow tube 142 penetrating through the stator 101 of a SRM with its a first end having an opening on the salient cylinder 10151 of the SRM and its a second end having an opening outside the SRM such that air can flow between outside the SRM and the “rotor-salient-cylinder space” of the SRM. The orientation of a blowing air out of the second air-in passageway 142 trys to be as possible as in parallel to the orientation of the rotation of the rotor to produce the maximun rotating force of the rotor. Air out of the second air-in passageway 142 can also be used to slow down a rotating rotor functioning as a brake.

FIG. 3d has shown the first air-in passageway 141, the second air-in pasageway 142, and the air-out passageway 143 in 3-dimension front view of the SRM of FIG. 3c. Obviously, the first air-in passageway 141, the second air-in pasageway 142, and the air-out passageway 143 in the embodiment of FIG. 3c is an example of the first type air passageway discussed above.

The sizes and shapes of the hollow tubes respectively constructing the first air-in passageway, the second air-in pasageway, and the air-out passageway are not limited, for example, the sizes of them can be different from each other.

The pole of the rotor has a certain length such that a plurality of holes on the salient cylinder 19151 along the axial orientation to blow the pole of rotor to rotate may be needed.

An embodiment is shown in FIG. 3e and FIG. 3f, which are respectively a top view of a first type SRM and a 3-dimension front view of the SRM of FIG. 3e without showing its rotor and the salients for the purpose of simplifying the drawing. A dotted circle 16111, 16121, 16131, 16141, 16151, 16161, 16211, 16221, 16231, 16241, 16251, 16261, and 1711 respectively of hollow tubes 1611, 1612, 1613, 1614, 1615, 1616, 1621, 1622, 1623, 1624, 1625, 1626, and 171 indicate holes opened on the salient cylinder 10151. A first air-in passageway is formed by a plurality of hollow tubes 1611, 1612, 1613, 1614, 1615, and 1616 and a second air-in passageway is formed by a plurality of hollow tubes 1621, 1622, 1623, 1624, 1625, and 1626. Air respectively out of the first air-in passageway and the second air-in passageway to blow the rotor pole to rotate are opposite. The holes opened on the salient cylinder 16111, 16121, 16131, 16141, 16151, and 16161 are in a row and the holes opened on the salient cylinder 16211, 16221, 16231, 16241, 16251, and 16261 are in a row.

The sizes and the shapes of the hollow tubes constructing the first air-in passageway and the second air-in passageway are not limited and the sizes and the shapes of the hollow tubes may be different from each other.

FIG. 3g has shown the SRM of FIG. 3e and FIG. 3f in different view with a broken window on the stator 101.

Another embodiment, shown in FIG. 3h and FIG. 3i, which are respectively a top view of a first type SRM and a 3-dimension front view of the SRM of FIG. 3h without showing its rotor and salients for the purpose of simplifying the drawing. FIG. 3h has shown a first air-in passageway 181, a second air-in passageway 182, and an air-out passageway 171. The first air-in passageway 181 and the second air-in passageway 182 are examples of the second type air passageway discussed above.

A plurality of dotted circles 1811, 1812, 1813, and 1814 of the first air-in passageway 181 and a plurality of dotted circles 1821, 1822, 1823, and 1824 of the second air-in passageway 182 indicate holes opened on the salient cylinder 10151. A hollow tube 1815 and a hollow tube 1825 penetrate through the stator 101 and a hollow tube 1816 and a hollow tube 1826 are disposed between the salient cylinder 10151 and the statot cylinder 10161.

The embodiment of FIG. 3h and FIG. 3i advantages fewer holes penetrating through the stator 101.

An embodiment, shown in FIG. 3j and FIG. 3k, which are respectively a top view of a first type SRM and a 3-dimension front view of the SRM of FIG. 3j without showing its rotor and salients for the purpose of simplifying the drawing. FIG. 3k has shown a first air-in passageway 186, a second air-in passageway 187, and an air-out passageway 171.

The first air-in passageway 186 and the second air-in passageway 187 of the embodiment of FIG. 3j and FIG. 3k are examples of the third type air passageway discussed above.

FIG. 3k has shown a plurality of holes 1861, 1862, 1863, 1864, and 1865 of the first air-in passageway 186 are on the salient cylinder 10151 and a plurality of holes 1871, 1872, 1873, 1874, and 1875 of the second air-in passageway 187 are on the salient cylinder 10151. A first hollow tube 1866 and a second hollow tube 1876 respectively of the first air-in passageway 186 and the second air-in passageway 187 are disposed between the stator cylinder 10161 and the salient cylinder 10151 as shown in FIG. 3j and FIG. 3k. The first hollow tube 1866 and the second hollow tube 1876 have air input entrance at the open end of the first type SRM.

The embodiment of FIG. 3j and FIG. 3k advantages no openings penetrating through the stator 101 instead the first hollow tube 1866 and the second hollow tube 1876 have air input entrance at the open end of the SRM.

Another embodiment, FIG. 3l has shown a top view of the first type SRM with two air-in passageways and FIG. 3m is the 3-dimension side view of FIG. 3l. FIG. 3l has shown a first air-in passageway formed by four hollow tubes 191, 192, 193, and 194 penetrating the stator 101 and a second air-in passageway formed by four hollow tubes 195, 196, 197, and 198 penetrating the stator 101. A plurality of dotted circles 1911, 1921, 1931, 1941, 1951, 1961, 1971, and 1981 indicate the holes opened on the salient cylinder. The embodiment of FIG. 3m has shown the four holes of the first air-in passageway and the four holes of the second air-in passageway respectively are not in a row parallel to the axial orientation of the SRM.

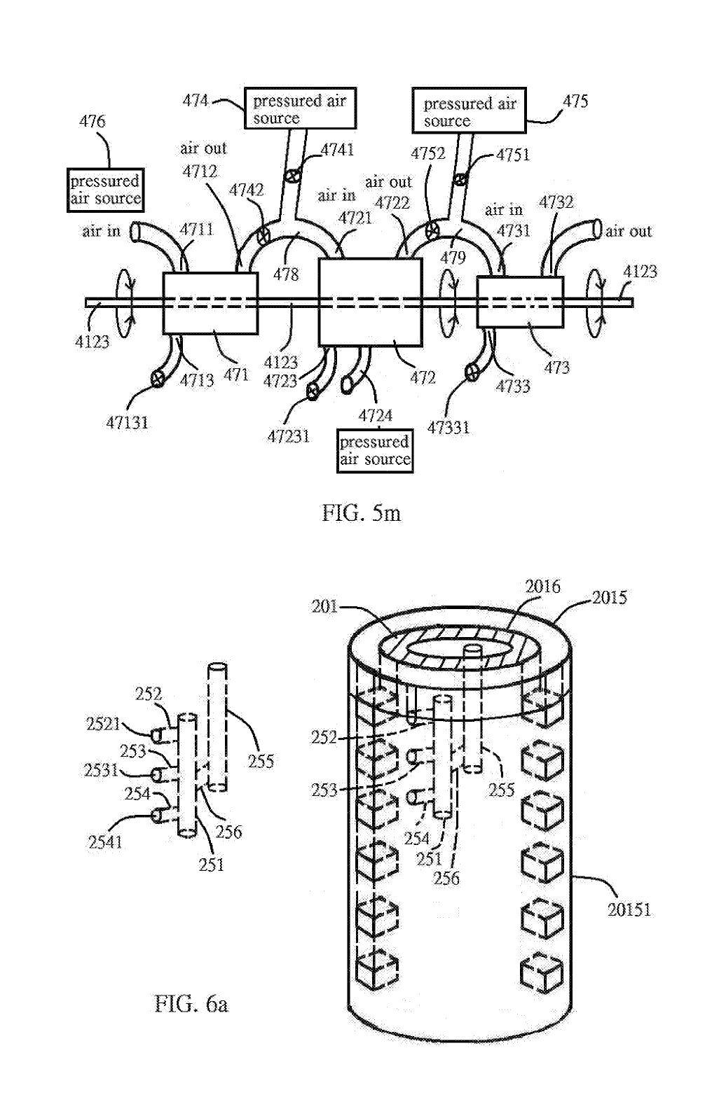

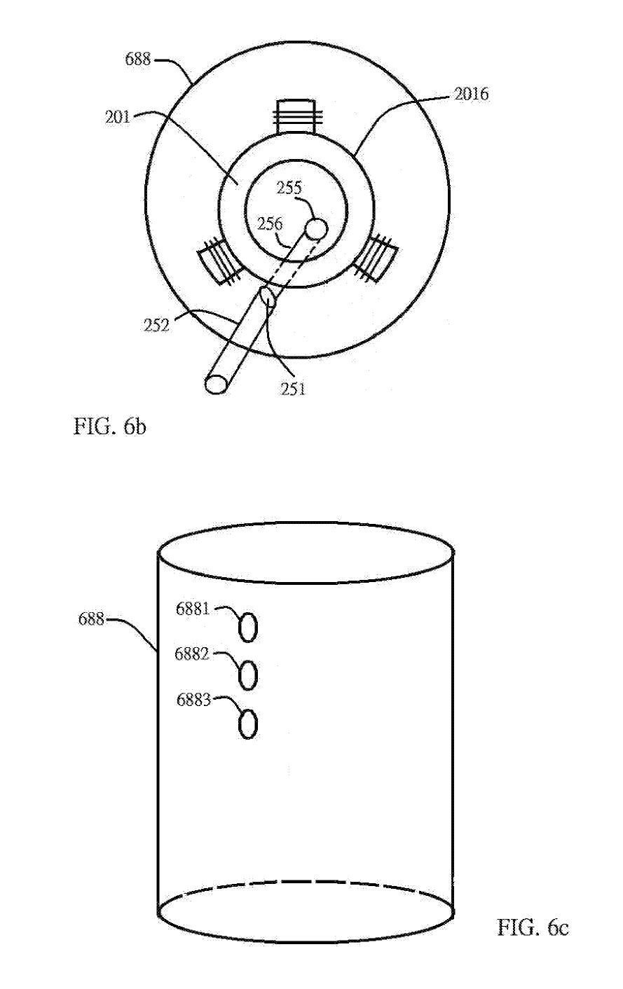

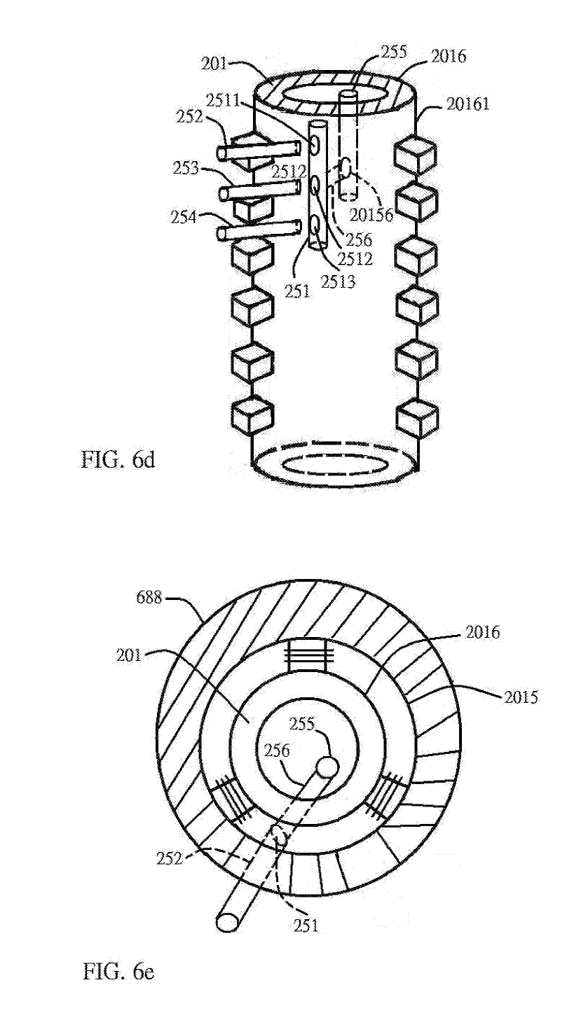

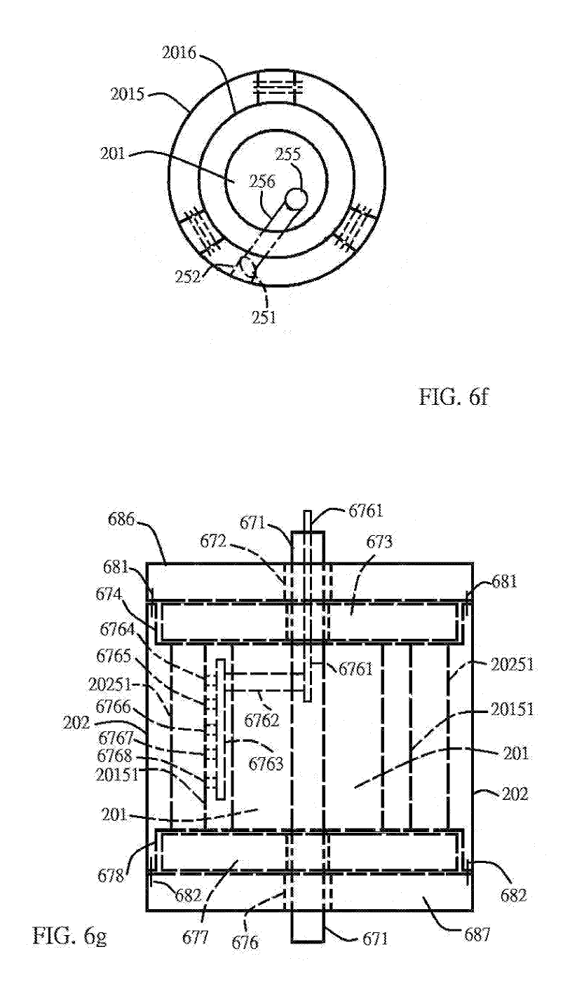

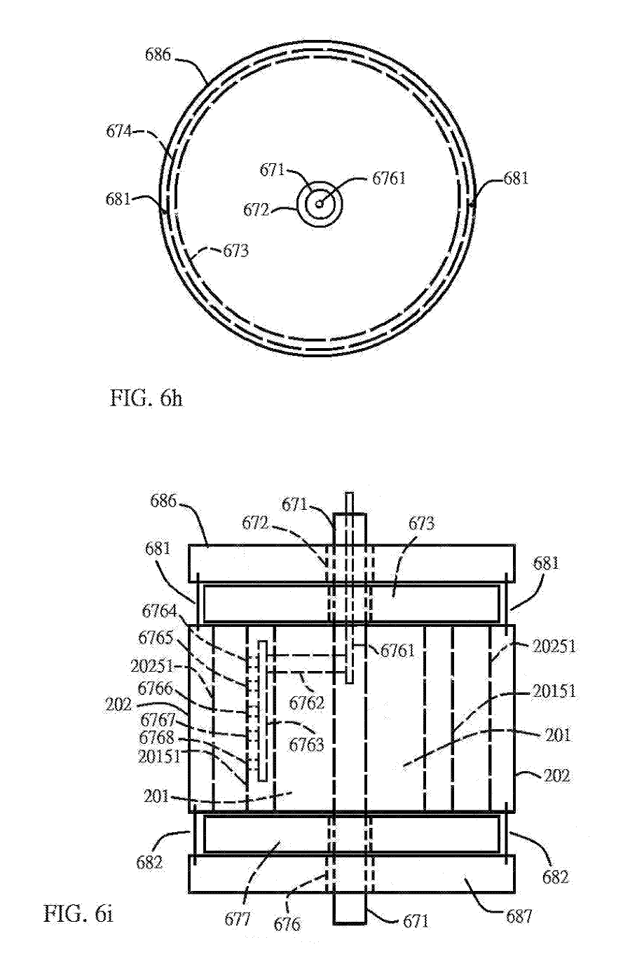

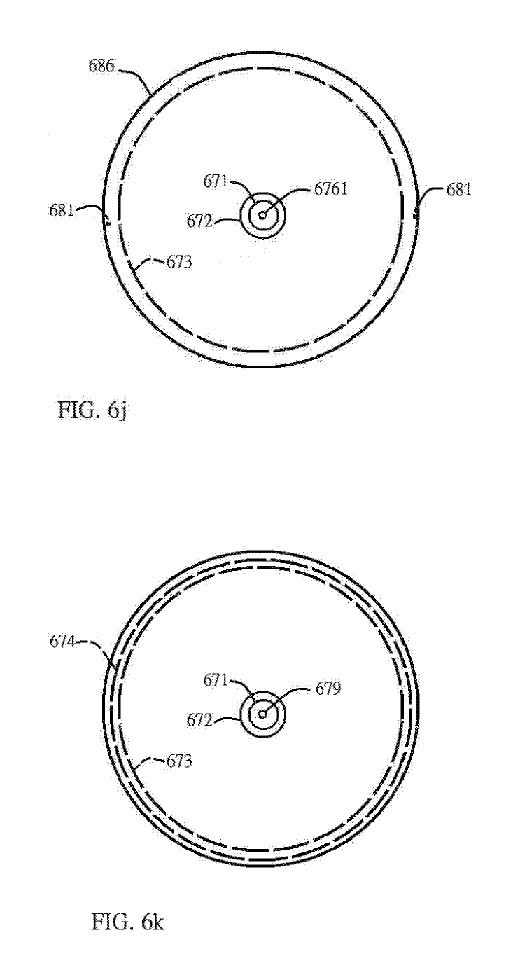

Air passageway in the second type SRM is discussed in an embodiment shown in FIG. 6a. FIG. 6a has shown an embodiment of an air passageway of a second type SRM formed by a first hollow tube 251, a second hollow tube 252, a third hollow tube 253, a fourth hollow tube 254, a fifth hollow tube 255, and a sixth hollow tube 256.

A sixth hollow tube 256 penetrating through the stator 201 of the second type SRM is the first type tube.

A first hollow tube 251 disposed between the stator cylinder 20161 and the salient cylinder 20151 is a second type tube.

A second hollow tube 252, a third hollow tube 253, and a fourth hollow tube 254 connecting the holes opened on the salient cylinder 20151 are third type tubes.

The fifth hollow tube 255 can be viewed as an extension of the first type tube as the sixth hollow tube 256.

The air passageway has air input entrance at the open end of the second type SRM.

Air flowing a stationary salient cylinder will produce air laminal flow on its surface causing pressure difference, which may be positive or negative. The pressure difference doesn't always occur but it exists. A negative pressure difference such as vacuum phenomenon on the stationary surface of the salient cylinder can cause an unnecessary pull force to the rotor, which can be a very serious problem at high rotating speed. A solution to the problem is to equip air passageway with an one-way check valve which only allows air to flow uni-direction into the chamber. A negative pressure difference produced on surface of the salient cylinder 10151 will suck air outside the SRM through the one-way check valve into the chamber to neutralize the pull force to the rotor. The one-way check valve prohibits air in the chamber from flowing out of the chamber when air pressure in the chamber is higher than air pressure outside the SRM. The air laminal flow phenomenon more likely occurs during air flowing into a chamber. For the purpose of convenience, an air passageway equipped with one-way check valve for cancelling the negative pressure difference effect is called vacuum-effect-cancelling air passageway or compensating air passageway in the present invention.

Air force and electric force acting on the same rotor on a same on-duty cycle expresses frequency and phase synchronizations resulting in amplitude synchronization such that the output force is the modulation of the air force and the electric force acting on the rotor. That explains the reason why the title of the invention “force modulator” is adopted. For the purpose of convenience, a force modulator based on a first type SRM is called first type force modulator and a force modulator based on a second type SRM is called second type force modulator in the present invention.

Electrical current flowing through the coils and the rotation of the rotor will produce heat, which can be cooled down and taken away by air blowing into the chamber. The heated air also advantages to heighten air pressure.

A vacuum-effect-cancelling air passageway or a compensating air passageway can be the first type air passageway, the second type air passageway, the third type air passageway, or any combinations of them. Each air-in entrance of a compensating air passageway should be equipped with an one-way check valve.

FIG. 3y has shown an example of a vacuum-effect-cancelling air passageway or a compensating air passageway formed by a plurality of hollow tubes 581, 582, 583, 584, and 589 and a first one-way check valve 5817 installed with the hollow tube 581 and a second one-way check valve 5818 installed with the hollow tube 589. Obviously, shown in FIG. 3y, the vacuum-effect-cancelling air passageway has three holes 591, 592, and 593 opened on the salient cylinder 10151.

The air-in air passageway, the air-out passageway, and the compensating air passageway in the present invention can be controllable, for example, they can be on/off or open/close switched, the flow rate flowing through them is controllable, and orientation of the flowing through them is controllable such as the compensating air passageway discussed above.

A method and a procedure to form the salient cylinder 10151 and air passageways of the stator of a first type SRM and a second type SRM are respectively revealed.

The stator of SRM has many coils for magnetization, for example, coils winding on its salients and coils winding on the stator, such that a matter to fill in between the stator cylinder and the salient cylinder can be a matter having flowability property such as in the form of liquid during the filling-in time and the filled-in matter will become hardened after the filling-in process to strength the support to the salient cylinder. The hardened material can be further polished to form smooth surface.

The filled-in matter having flowability advantages its ability to easier fill into tiny space such as spaces between coils, spaces between salients, spaces between salients and coils, and spaces around the hollow tubes of the air passageway. The filled-in matter is not limited, for example, it can be a matter having flowability at a first temperature and it becomes hardened at a second temperature that can be higher or lower than the first temperature, or it can be a plurality of physically mixed agents having flowability and the mixed agents become hardened as the result of the chemical reactions of the mixed agents. For example, an embodiment, at least agent A or agent B contains an epoxy or an epoxy relative and the physical mixture of agent A and agent B has flowability and the mixure of agent A and agent B will become hardened as the result of the chemical reactions of agent A and agent B. Baking, high pressured filled-in, and centrifugal force by a rotating movement may involve in the hardening process to improve filled-in and hardening quality. For example, baking can easier vaporize air in the filled-in matter, high pressured filled-in can increase the density of the filled-in matter, and centrifugal force caused by rotation on the filled-in matter can also help to increase the density of the filled-in matter.

A method and a procedure to form the salient cylinder and air passageways of the stator of the first type SRM prepares a coiled stator, at least a holes penetrating through the stator if needed, a plurality of hollow tubes, and a tube-support device having a plurality of holes. The tube-support device is for sustaining and positioning the hollow tubes when forming air passageways and forming an area with the stator to be filled by the filled-in matter discussed above. The tube-support device 588 is disposed inside the stator 101 of a first type SRM and the diameter of the hole of the tube-support device 588 is a little bit larger than that of the hollow tube for being inserted by the hollow tube.

Hollow tube is for air to flow through it and its shape is not limited, for example, an embodiment, it can be cylindrical. The shape of the tube-support device is not limited, for example, it can be cylindrical. An embodiment using cylindrical hollow tubes and a cylindrical tube-support device to form the salient cylinder and air passageways of the stator of a first type SRM is shown in FIGS. 5c and 5d.

FIG. 5c and FIG. 5d have respectively shown the top view of the stator 101 of the first type SRM and a 3-dimension front view of the stator 101 of FIG. 5c without showing the salients for the purpose of simplifying the drawing. FIG. 5c and FIG. 5d have respectively shown the coiled stator 101 having a plurality of holes therethrough, a plurality of hollow tubes 581, 582, 583, 584, 585, 586, and 587, and a tube-support device 588 having a plurality of holes. The tube-support device 588 has a plurality of holes for sustaining or positioning at least a portion of the plurality of hollow tubes and forms an area with the stator to be filled by the filled-in matter. The diameter of the tube-support device 588 is equal to or smaller than that of the salient cylinder so that the tube-support device 588 can be disposed inside the stator 101. And, the holes of the tube-support device 588 are for taking the hollow tubes so that the diameter of a hole is a little bit larger than that of its associated hollow tube. The diameter of a hole penetrating through the stator 101 is a little bit larger than that of its an associated hollow tube so that the hollow tube can penetrate through the hole of the stator 101.

FIG. 5d has shown that the stator 101 of a first type SRM has a first hole 10181 and a second hole 10182 penetrating through the stator 101. For the purpose of convenience, the first hole 10181 and the second hole 10182 are respectively called as a first stator hole and a second stator hole. FIG. 5d has also shown the tube-support device 588 disposed inside the stator 101 and the tube-support device 588 has a plurality of holes 5881, 5882, 5883, and 5884 respectively for sustaining a hollow tube.

As defined earlier, the hollow tube penetrating the stator 101, the hollow tube disposed in the space formed between the stator cylinder and the salient cylinder, and the hollow tube going through a hole opened on the salient cylinder are respectively called as a first type hollow tube or first type tube in short, a second type hollow tube or second type tube in short, and a third type hollow tube or third type tube in short in the embodiment. Please note that a hollow tube going through a hole of the stator 101 and a hole of the salient cylinder is viewed as a first type hollow tube. For example, shown in FIG. 5d, a first hollow tube 581 and a seven hollow tube 587 respectively going through the first stator hole 10181 and the second stator hole 10182 are respectively a first type hollow tube, a second hollow tube 582 and a fifth hollow tube 585 disposed in the space between the stator cylinder and the salient cylinder are respectively a second type hollow tube, and a third hollow tube 583, a fourth hollow tube 584, and a sixth hollow tube 586 respectively going through a hole opened on the salient cylinder are respectively a third type hollow tube.

The first hollow tube 581 connects the second hollow tube 582 that also connects the third hollow tube 583 and a fourth hollow tube 584. The third hollow tube 583 and the fourth hollow tube 584 respectively insert into a second hole 5882 and a third hole 5883 of the tube-support device 588. The fifth hollow tube 585 connects the sixth hollow tube 586 that inserts a fourth hole 5884 of the tube-support device 588. A seven hollow tube 587 goes through the second hole 10182 penetrating through the stator 101 and a first hole 5881 of the tube-support device 588.

First, the second hollow tube 582 connects the third hollow tube 583 and the fourth hollow tube 584 and the fifth hollow tube 585 connects the sixth hollow tube 586. And then, the third hollow tube 583, the fourth hollow tube 584, and the sixth hollow tube 586 are respectively inserted through and supported by the holes 5882, 5883, and 5884 of the tube-support device 588 disposed outside the stator 101 as shown in FIG. 5j, which has shown the tube-support device 588 in 3-dimension front view disposed outside the stator 101. The assembly of FIG. 5j is then disposed into the stator 101 as shown in FIG. 5k and FIG. 5l, which are respectively its top view and 3-dimension front view without showing the salients for the purpose of simplifying the drawing. After the tube-support device 588 disposed inside the stator 101 as shown in FIG. 5k and FIG. 5l, the first type tube goes through the hole of the stator to either go all the way through the hole of the tube-support device 588 or connect the second type tube as respectively shown by the seventh hollow tube 587 and the first hollow tube 581 shown. Please note that the second hollow tube 582 has a connector 5821 to connect the first hollow tube 581. More detailed about the connection between two hollow tubes can be referred by the embodiments of FIG. 5h and FIG. 5i above.

Fill a matter having flowability into a space between the tube-support device 588 and the stator 101 as shown by a shady area in FIG. 5g and harden the matter after the fill-in process. Drill and cut off the unwanted hardened matter and the unwanted hollow tubes until the salient cylinder 10151 is formed as shown in FIGS. 5e and 5f, which are respectively the top view of a stator 101 of the first type SRM after the cutting-off process and a 3-dimension front view of the stator 101 of FIG. 5e without showing the salients for the purpose of simplifying the drawing. A plurality of dotted circles 591, 592, 593, 594, 595, and 596 shown in FIG. 5f represent the holes opened on the salient cylinder 10151. Obviously, the salient cylinder 10151 and air passageways are formed. The surface of the salient cylinder can be coated with wear-resisting material such as diamond-like material to improve its wear-resisting ability. The filled-in material can strength the support to the salient cylinder and strength the hold to the air passageways.

A prodecure to form the salient cylinder and air passageways of the stator of the first type SRM comprising the steps of: (1) preparing a first type hollow tube if has any, a second type hollow tube, and a third type hollow tube, a coil-wound stator of a first type SRM, at least a hole penetrating through the stator if needed, and a tube-support device having at least a hole, (2) connecting the second type hollow tube with the third type hollow tube that positions through the hole of the tube-support device disposed outside the stator, (3) disposing the tube-support device equipped with the second type tube and the third type tube into the stator, (4) inserting the first type tube through the hole of the stator and then either through the hole of the tube-support device or connecting the second type tube, (5) filling a matter having flowability into a space between the stator and the tube-support device, (6) hardening the matter, and (7) cutting off the un-wanted hardened matter and the unwanted hollow tubes to form the salient cylinder and the hole opened on the salient cylinder, (8) coating the surface of salient cylinder with a wear-resisting material such as diamond-like material. Please note that if no hole penetrating through the stator, then a first type hollow tube is not needed and step (4) is skipped.

A method and a procedure to form the salient cylinder and air passageways of the stator of the second type SRM is similiar to that of the first type SRM. A method and a procedure to form the salient cylinder and air passageways of the stator of the second type SRM include a first type tube, a second type tube, and a third type tube, a coil-wound stator, at least one hole penetrating through the stator, and a tube-support device having at least one hole. The tube-support device is for sustaining and positioning the hollow tubes and forming an area with the stator to be filled by the filled-in matter discussed above. The stator 101 is disposed inside the tube-support device 588 which has at least one hole with its diameter a little larger than that of the hollow tubes for being inserted by the hollow tube.

The hollow tube is for air to flow through it and its shape is not limited, for example, an embodiment, it can be cylindrical. The shape of the tube-support device is not limited, for example, an embodiment, it can be cylindrical. An embodiment using cylindrical hollow tubes and a cylindrical tube-support device to form the salient cylinder and air passageways of the stator of a second type SRM is shown in FIGS. 6a, 6b, 6c, 6d, 6e, and 6f.

FIG. 6c has shown a 3-dimension front view of the tube-support device 688 of FIG. 6b having a plurality of holes 6881, 6882, and 6883 therethrough.

FIG. 6d has shown a 3-dimension front view of the stator 201 of the second type SRM and a hole 20156 penetrating through the stator 201. First step, a second type hollow tube 251 disposed in the “stator-salient-cylinder space” formed between the stator cylinder 20151 and the salient cylinder 20161 connects a first type hollow tube 256 that connects a first type extension hollow tube 255 through the hole 20156 penetrating through the stator 201. Please note that the first type extension hollow tube 255 is used to conduct air along its axial orientation out and can be viewed as an extension of the first type hollow tube 256. FIG. 6d has also shown the second type hollow tube 251 having three connectors 2511, 2512, and 2513.

Then, dispose the stator 201 after the first step inside the tube-support device 688.

Then, a first third type hollow tube 252, a second third type hollow tube 253, and a third type hollow tube 254 connect the second type hollow tube 251 respectively through the three connectors 2511, 2512, and 2513.

Fill a matter having flowability such as a form of liquid into a space between the tube-support device 688 and the stator as shown in FIG. 6b, which is the top view of the stator 201 and the tube-support device 688, and harden the matter after the filled-in process. Drill and cut off the unwanted hardened matter and the unwanted hollow tubes as shown by shady area until the salient cylinder 20151 is formed as shown in FIG. 6e. FIG. 6f and FIG. 6a have respectively shown a top view of the final result and 3-dimension front view of FIG. 6f. Obviously, the surfaces of all the salients of the stator 201 are on the salient cylinder 20151 and air passageways are formed with the stator 201. The surface of the salient cylinder 20151 can be coated with wear-resisting material such as diamond-like material to increase its wear-resisting ability.

A prodecure to form the salient cylinder and air passageways of the stator of the second type SRM comprising the steps of:

(1) preparing a coil-wound stator of a second type SRM having at least one stator hole therethrough, at least a first type hollow tube penetrating through the stator, at least a first type extension hollow tube, at least a second type hollow tube disposed in the “stator-salient-cylinder space” formed between the stator cylinder and the salient cylinder, at least a third type hollow tube having a hole opened on the salient cylinder, and a tube-support device having at least one hole,

(2) connecting the second type hollow tube with the first type hollow tube that connects the first type extension hollow tube through the stator hole of the stator,

(3) disposing the coil-wound stator after the step (2) inside the tube-support device,

(4) inserting the third type tube through the hole of the tube-support device to connect the second type tube disposed between the salient cylinder and the stator cylinder,

(5) filling a matter having flowability such as a form of liquid into a space between the stator and the tube-support device,

(6) hardening the matter,

(7) cutting off the un-wanted hardened matter and the unwanted hollow tubes to form the salient cylinder, and

(8) coating the surface of salient cylinder with a wear-resisting material such as diamond-like material.

For both the first type SRM and the second type SRM, a chamber is a space between two neighboring poles of the rotor in the “rotor-salient-cylinder space” with its first open end and second open end respectively covered by a first lid and a second lid as discussed earlier.

An embodiment, shown in FIGS. 3s and 3n, which are respectively a top view of a first type SRM and a side view of the SRM of FIG. 3s. The first type SRM has a first open end and a second open end. FIG. 3n has shown a shaft 353 fixed through the rotor 102 of the SRM. Assumimg the first open end and the second open end of the SRM are symmetry so that the top view of only the first open end is shown.

At least the “rotor-salient-cylinder space” defined between the “rotor cylinder” 10251 and the salient cylinder 10151 at the first open end and the second open end of the SRM are respectively covered by an upper lid 351 through a first bearing 354 fixed on the shaft 353 and a lower lid 352 through a second bearing 355 fixed on the shaft 353. FIG. 3n and FIG. 3s have also shown an air passageway formed by a second type hollow tube 585 disposed between the stator cylinder 10161 and the salient cylinder 10151 and a third type hollow tube 586 having a hole opened on the salient cylinder 10151. The air passageway has an air entrance at the first open end of the SRM.

The upper lid 351 and the lower lid 352 are fixed to the stator 101 shown by a device 388, and, the rotor 102 and a rotor-connected shaft 353 rotate against the upper lid 351 and the lower lid 352 respectively through the first bearing 354 and the second bearing 355.

Another embodiment, shown in FIGS. 3r and 3o, which are respectively a top view of a first type SRM and a side view of the SRM of FIG. 3r. The first type SRM has a first open end and a second open end. FIG. 3o has shown a shaft 363 fixed through the rotor 102 of the SRM. Assumimg the first open end and the second open end of the SRM are symmetry so that the top view of only the first open end is shown.

At least the “rotor-salient-cylinder space” defined between the “rotor cylinder” 10251 and the salient cylinder 10151 of the first open end and the second open end of the SRM are respectively covered by a first thrust bearing 361 and a second thrust bearing 366 respectively mounted on the shaft 363. An upper cover 362 covers on the first thrust bearing 361 through a first bearing 365 fixed on the shaft 363 and a lower cover 367 covers on the second thrust bearing 366 through a second bearing 369 fixed on the shaft 363.

FIG. 3r and FIG. 3o have also shown an air passageway formed by a second type hollow tube 585 disposed between the stator cylinder 10161 and the salient cylinder 10151 and a third type hollow tube 586 having a hole opened on the salient cylinder 10151. The air passageway has an air entrance at the first open end of the SRM.

The upper cover 362 and the lower cover 367 are fixed to the stator 101 respectively through by a first connector 3621 and a second connector 3671 seen in FIG. 3o.

The first thrust bearing 361 and the second thrust bearing 366 are for absorbing or buffering an axial shock.

The shaft 363 and the stator 101 make relative rotational movement through the first bearing 365 and the second bearing 369.

An embodiment is based on the embodiment of FIG. 3r and FIG. 3o except a length of the outside stator is longer than that of the rotor 102 by a thickness of the first thrust bearing 361 and the second thrust bearing 366 at both open ends to respectively form a round slot so that the first thrust bearing 361 and the second thrust bearing 365 can be respectively disposed in two round slots as shown in FIG. 3q and FIG. 3p, which are respectively a top view of a first type SRM and a side view of the SRM of FIG. 3q. A first round slot 3677 and a second round slot 3678 at both ends of the SRM are seen in FIG. 3p and the first thrust bearing 361 and the second thrust bearing 366 are respectively disposed in the first round slot 3677 and the second round slot 3678. Please note that the air passageway penetrates through the upper cover 362 out.

The embodiment of FIGS. 3q and 3p advantages over the embodiment of FIG. 3r and FIG. 3o for improving air-tight of the chambers at two open ends.

An embodiment, shown in FIGS. 6j and 6i, which are respectively a top view of a second type SRM and a side view of the SRM of FIG. 6j. The second type SRM has a first open end and a second open end. Assumimg the first open end and the second open end of the SRM are symmetry so that the top view of only the first open end is shown. FIG. 6i has shown a shaft 671 fixed through the center of the stator 201 of the SRM.

At least the “rotor-salient-cylinder space” defined between the “rotor cylinder” 20251 and the salient cylinder 20151 of the first open end and the second open end of the second type SRM are respectively covered by a first thrust bearing 673 and a second thrust bearing 677 respectively mounting on the shaft 671 fixed to the stator 201. An upper cover 686 covers on the first thrust bearing 673 through a first bearing 672 fixed to the shaft 671 and a lower cover 687 covers on the second thrust bearing 677 through a second bearing 676 fixed to the shaft 671. The shaft doesn't rotate.

FIG. 6j and FIG. 6i have shown a second type air passageway formed by a first type extension hollow tube 6761 going through the shaft 671, a first type hollow tube 6762 penetrating through the stator 201, and a second type hollow tube 6763 disposed between the stator cylinder and the salient cylinder, and a plurality of third type tubes respectively having a hole 6764, 6765. 6766, 6767, and 6768 opened on the salient cylinder 20151. The second type hollow tube 6763 connects the plurality of third type tubes and the first type hollow tube 6762 that connects the first type extension hollow tube 6761. Obviously, the second type air passageway has air-in or air-out going through the shaft 671.

The upper cover 686 and the lower cover 687 are fixed to the rotor 202.

The first thrust bearing 673 and the second thrust bearing 677 are for absorbing or buffering an axial shock.

The rotor 202 and the stator 201 make relative rotational movement through the first bearing 672 and the second bearing 676. Another embodiment is based on the embodiemnt of FIG. 6j and FIG. 6i except a length of the rotor is longer than that of the stator 201 by a thickness of the first thrust bearing 673 and the second thrust bearing 677 at both open ends to respectively form a round slot so that the first thrust bearing 673 and the second thrust bearing 677 can be respectively disposed in two round slots 674 and 678 as shown in FIG. 6h and FIG. 6g, which are respectively a top view of a second type SRM and a side view of the SRM of FIG. 6h. A first round slot 674 and a second round slot 678 are seen in FIG. 6g and FIG. 6h and the first thrust bearing 673 and the second thrust bearing 677 are respectively disposed in the first round slot 674 and the second round slot 678.

The embodiment of FIGS. 6h and 6g advantages over the embodiment of FIG. 6j and FIG. 6i for improving air-tight of the chambers at both open ends.

As discussed earlier, air in a chamber can leak to a neighboring chamber through a tiny gap between the salient cylinder and the pole of the rotor. Each chamber should have a significant air-tightness so that the gap 1056 should be as air-tight as possible to realize this.

For the purpose of convenience, a device to air-tight the gap between the salient cylinder and the pole of the rotor of a SRM is called “ air-tight bearing” in the present invention. The term “bearing” is used because it describes a relative movement between the stationary stator and the rotating rotor poles. And, the lubricity of the air-tight bearing between the stationary stator and the rotating rotor poles should also be considered.

An embodiment of the air-tight bearing is shown in FIG. 3t. FIG. 3t has shown a surface in a larger scale for easier observation facing the salient cylinder of each pole of the rotor.

FIG. 3t has shown a plurality of long-shaped slots built on the surface of each pole of the rotor and a plurality of cylindrical rollers with one cylindrical roller disposed in each slot.

Right drawing of FIG. 3t has shown a plurality of slots 881^{˜}895 engraved on the surface of the pole of the rotating rotor and a plurality of cylindrical rollers 8811, 8821, 8831, 8841, 8851, 8861, 8871, 8881, 8891, 8901, 8911, 8921, 8931, 8941, and 8951 respectively disposed in the plurality of slots 881^{˜}895. The size of each cylindrical roller may be different from each other so that the size of each slot taking the roller may be different from each other.

An embodiment, FIG. 3u and FIG. 3x have respectively shown a side view and a top view of a slot 878 engraved on the surface of a pole of the rotor in a larger scale for easier observation. The side view has shown a tiny gap 1056 between the salient cylinder 10151 and the rotor-rotation cylinder 10261.

At least a portion of a cylindrical roller 8781 is disposed in the slot 878 and at least a portion of the cylindrical roller 8781 blocks in the gap 1056 functioning as air-tight in the gap 1056 as shown in FIG. 3u and FIG. 3w. FIG. 3w has shown the roller 8781 contactly rolls against the salient cylinder 10151 and FIG. 3u has shown the cylindrical roller 8781 is confined in the gap 1056 having a room to freely move and rotate in the gap 1056.

A centrifugal force by the rotation of the rotor 102 of the first type SRM can keep the roller 8791 away from the slot 879 side but by the salient cylinder 10151 side as a blockage against the air flowing through the gap 1056 as shown in FIG. 3v. The centrifugal force is especially good for the first type SRM.

If the cylindrical roller 8781 is made by a magnetized material the magnetized salients caused by current will attract the roller 8781 to side the salient cylinder 10151 functioning as air-tight in the gap 1056, which works on both the first type SRM and the second type SRM. Magnetized roller is especially good in initialization having electricity before the rotor gets speed to cause centrifugal force.

The movings and rotations of a roller in a slot and the gap 1056 may cause the roller to become twisted, become shape distorted, or even break if the roller is too long such that the length of a slot may be shorter than that of the pole of the rotor 102 as shown in FIG. 3t. If it is the case, a space between two rollers respectively in two slots exists and air can easily leak through the space.

FIG. 3t can be used to explain that. The length of each roller is shorter than that of the pole of the rotor 102 such that a space between two rollers exists. A third roller 8841 is used to block a space between a first roller 8861 and a second roller 8871 such that air has to detour the third roller 8841 to flow through the space resulting in lengthening the distance for air to flow through the space and the detour of air flow also transforms it into a pushing force on the rotor pole. Lengthening the distance and the time for air to flow through the space slows air leakage through the gap 1056. A better air-tight can be significantly obtained by slowing air leakage especially when the rotor rotates at very high speed. For the purpose of convenience, the third roller 8841 can also be called “blockage roller” in the present invention.

Obviously, more blockages produces more complicated air detouring pattern resulting in a better air-tight of the gap 1056 as shown in FIG. 3t. FIG. 3t has shown an air detouring pattern formed by a plurality of roller lines with a roller in a roller line can be a blockage roller to another roller lines. A left drawing of FIG. 3t has shown a complicated air detouring path. Each slot is such disposed that the orientation of the rotation of its cylindrical roller is parallel to that of the rotor 102.

When the rotor in high speeding rotation, only very short time for air stays in a chamber such that more complicated air detouring pattern having more blockage rollers provides good enough air-tight capability in the gap 1056.

The shape of the slot is not limited, for example, an embodiment, a semi-cylinder slot is shown in FIG. 3u.

The slots can be engraved on either the salient cylinder or the poles of the rotor. Obviously, it's more practically to engrave the slots on the poles of the rotor for smaller surface area compared to that of the salient cylinder.

The curved stream-line pole of the rotor has advantaged that: (1) single phase SRM is possible and the control circuit is easy to design, (2) output torque increases, (3) axial air flow in the chamber, and (4) a smaller moment inertia, which is good for stable rotation, is obtained.

Conventional SRM has featured straight poles of its rotor and the SRMs in the embodiments above in the present invention are based on straight rotor poles. Curved stream-line poles of the rotor of both the first type SRM and the second type SRM will be revealed in the present invention.

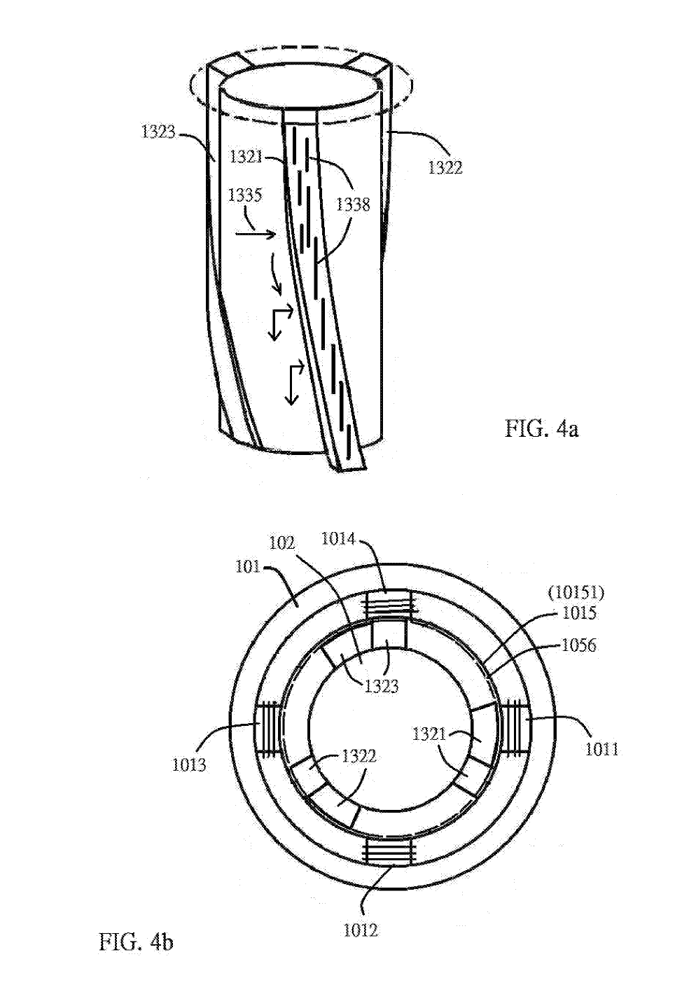

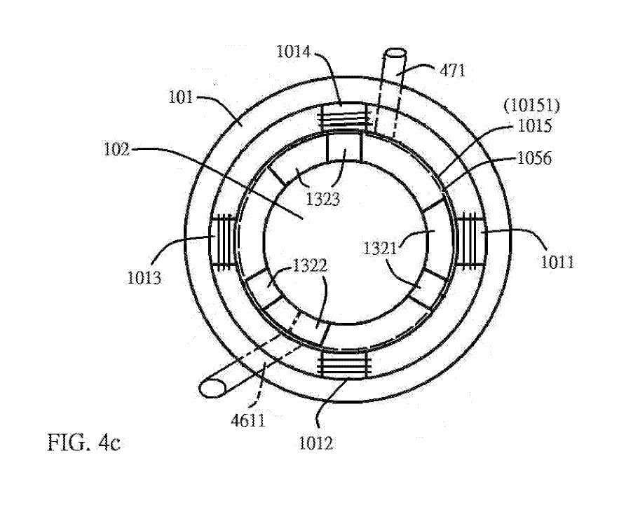

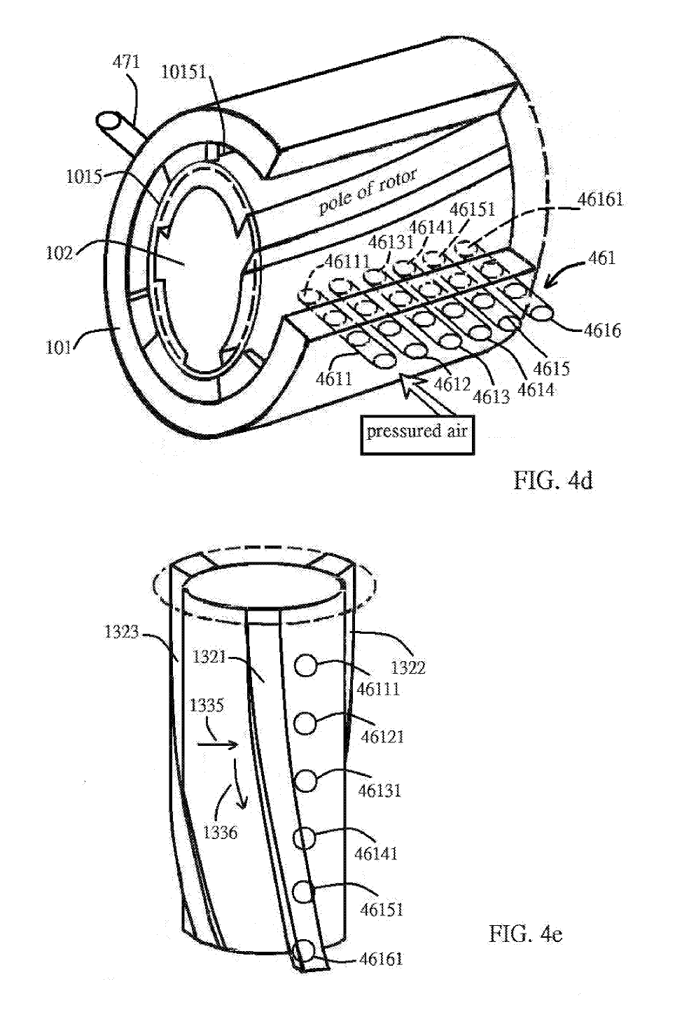

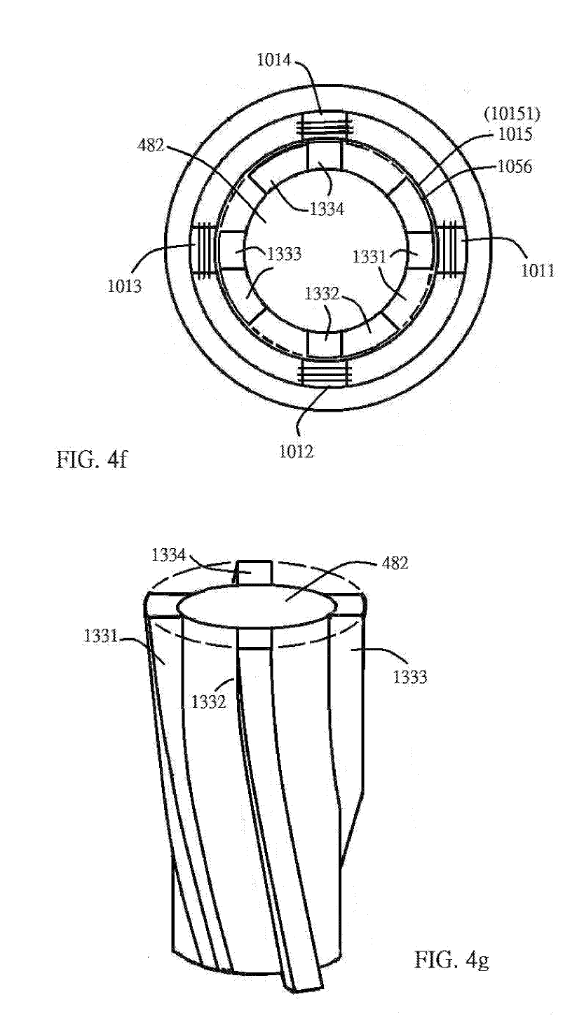

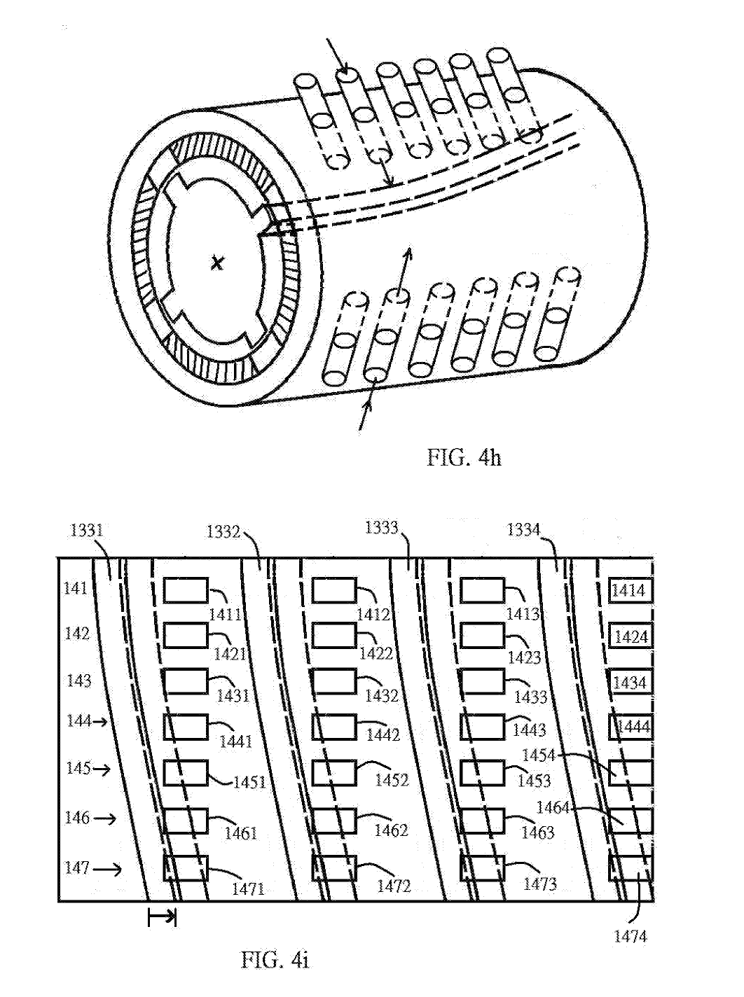

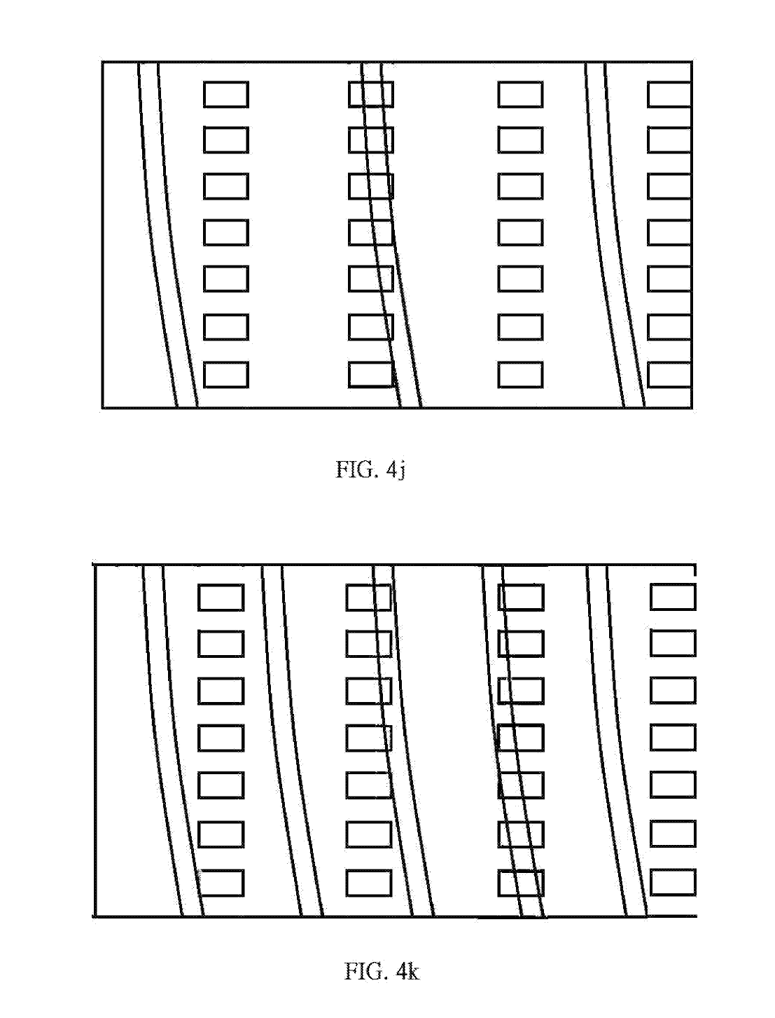

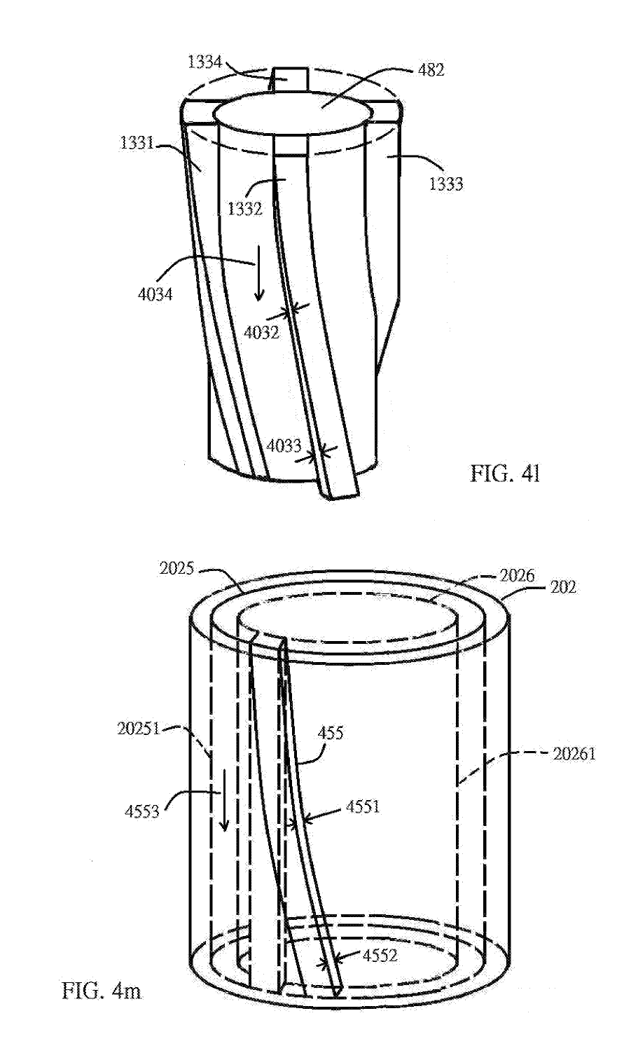

FIG. 4a has shown a 3-dimension front view of a rotor of a first type SRM with a plurality of curved stream-line rotor poles 1321, 1322, and 1323 with same height with each other. FIG. 4b has shown a top view of the first type SRM having the rotor of FIG. 4a.

Shown in FIG. 4a, a first arrow 1335 expresses an air flow in parallel to the orientation of the rotation of the rotor blows a curved stream-line rotor pole 1321 to make it rotate. The air flow will stream along the curve of the pushed rotating rotor pole 1321 such that a speed triangle having an axial component of the air flow is produced and with the help of the rotation of the rotor further driven by electrical power of the stator the air flow will be further accelerated in axial orientation. The orientation change of the air flow transforms into a force acting on the pole of the rotor and the speeding of the axial air flow can also be transformed into air pressure.

Negative air pressure such as vacuum phenomenon formed on the surface of the salient cylinder 10151 of curved stream-line rotor poles can be a very serious problem by the accelerated axial air flow in the chamber such that a vacuum-effect-cancelling air passageway or a compensating air passageway may be needed to neutralize the phenomenon.

The top view of the rotor with curved stream-line rotor poles of the first type SRM seen in FIG. 4b has also shown an improved mass distribution resulting in smaller moment inertia, which advantages for more smooth rotation of the rotor. FIG. 4a has also shown a plurality of slots 1338 built on the surface of each curved stream-line pole of the rotor and a roller in each slot rotates in parallel to the rotation of the rotor as revealed earlier in the embodiments 3t, 3u, 3v, 3w, and 3x.

An embodiment of a first type force modulator, the top view of the first type SRM of FIG. 4b implemented with an air-in passageway 461 and an air-out passageway 171 has been shown in FIG. 4c. FIG. 4d is a 3-dimension side view of the first type force modulator of FIG. 4b and a curved stream-line rotor pole is seen.

FIG. 4d has shown the air-in passageway 461 is formed by a plurality of hollow tubes 4611, 4612, 4613, 4614, 4615, and 4616 respectively having an hole 46111, 46121, 46131, 46141, 46151, and 46161 opened on the salient cylinder in a row along the axial orientation of the SRM.

FIG. 4e has used a plane to explain a relative position between the holes 46111, 46121, 46131, 46141, 46151, and 46161 opened on the salient cylinder 10151 of the rotor in 3-dimension frong view and the curved stream-line rotor for further discussion.

FIG. 4e has shown a sixth hole 46161 in a position where air just starts to flow into a first chamber formed between a first rotor pole 1321 and a third rotor pole 1323. With the rotor rotating counterclockwisely forward a little bit to pass a fifth hole 46151, air starts to flow into the first chamber through the fifth hole 46151. Obviously, with the rotor keeps rotating counterclockwisely forward, air will flow into the first chamber one by one through a fourth hole 46141, a third hole 46131, a second hole 46121, and a first hole 46111. Obviously, air flows into the first chamber to blow the rotor pole to make it rotate is in a sequence, or in other words, air has been frequency-modulated to act on the rotor pole to rotate.

The frequency-modulated air blowing lengthens the time for air to act on the pole of the rotor such that air power can be more effectively transferred onto the pole of the rotor.

A single phase SRM with curved stream-line rotor pole is possible now, in other words, the number of curved stream-line poles of the rotor can be equal to the number of the poles of the stator of a SRM. In other words, the present invention has revealed a single phase SRM having curved stream-line poles and a force modulator based on the single phase SRM having curved stream-line poles. A single phase SRM having curved stream-line poles or a force modulator based on the single phase SRM having curved stream-line poles has advantaged easier circuit controllability, which will be revealed in the following.

An embodiment, a 4/4 first type SRM with curved stream-line rotor poles is demonstrated in FIG. 4f and FIG. 4g. FIG. 4f has shown a top view of a 4/4 first type SRM with four curved stream-line rotor poles respectively shown as 1331, 1332, 1333, and 1334. A 3-dimension front view of the rotor 482 of the first type SRM of FIG. 4f is shown in FIG. 4g.

FIG. 4h has shown the SRM of FIG. 4f viewed from different angle, where a curved stream-line rotor pole is seen.

FIG. 4i has used a plane to explain how the salients of the stator to drive the curved stream-line poles of the rotor of the single phase SRM of FIG. 4f. For the purpose of convenience, the relative positions between the salients and the driven poles of the rotor are shown in a plane as shown in FIG. 4i for easier observation by respectively expanding the cylindrical stator and the cylindrical rotor of the SRM of FIG. 4f into a rectangle.

FIG. 4i has shown a plurality of salient columns or salient rings respectively as a first salient column or a first salient ring 141, a second salient column or a second salient ring 142, a third salient column or a third salient ring 143, a fourth salient column or a fourth salient ring 144, a fifth salient column or a fifth salient ring 145, a sixth salient column or a sixth salient ring 146, and a seventh column or a seventh salient ring 147. Each ring has four salients surrounding the four rotor poles 1331, 1332, 1333, and 1334, for example, the seventh salient ring 147 has four driving salients 1471, 1472, 1473, and 1474 surrounding the four driven rotor poles 1331, 1332, 1333, and 1334.

Each salient is coiled for magnetization and the coil on each salient is not shown in FIG. 4i for the purpose of simplicity of the drawing.

FIG. 4i has also shown the first rotor pole 1331, the second rotor pole 1332, the third rotor pole 1333, and the fourth rotor pole 1334 in solid line at position 1 and rotating forward the rotor poles a little bit obtains four rotor poles 1331, 1332, 1333, and 1334 in dotted line at position 2. From position 1 with the rotor poles in solid line to position 2 with the rotor poles in dotted line can be performed by magnetizing the four salients 1471, 1472, 1473, and 1474 of the seventh salient ring 147, four salients 1461, 1462, 1463, and 1464 of the sixth salient ring 146, four salients 1451, 1452, 1453, and 1454 of the fifth salient column 145, four salients 1441, 1442, 1443, and 1444 of the fourth salient column 144, and four salients 1431, 1432, 1433, and 1434 of the third salient column 143 one by one ring in a sequence.

A plurality of magnetized salients in a salient ring surrounding the poles of the rotor “twist” the rotor to rotate. The excitations by a plurality of magnetized salients of each salient ring acting on the rotor poles can be performed at a same time or one by one in a sequence in an on-duty period with each excitation lags a small phase behind a previous excitation in an on-duty period. And the excitations of two salient rings on the rotor poles can be performed at a same time or having a phase difference with each other in an on-duty period. In other words, the excitations of a salient ring can be at a same time or frequency-modulated and the excitations between two salient rings can be at a same time or frequency-modulated.

The excitations of one by one salient ring acting on the rotor poles as shown in the embodiment of FIG. 4i is called “ring by ring” excitation in the present invention. The embodiment of FIG. 4i has characterized the excitations by the seventh salient ring 147, the sixth salient ring 146, the fifth salient ring 145, the fourth salient ring 144, and the third salient ring 143 one by one salient ring in a sequence.

The ring-by-ring excitation on the curved stream-line rotor poles has characterized to distinguish from the conventional pole-by-pole excitation on the straight rotor poles and the ring-by-ring excitation on the curved stream-line rotor poles has also characterized easier circuit control on a single phase SRM.

With curved stream-line rotor poles, the number of poles of the rotor and the number of the poles of the stator of a first type SRM can be different or same. The ring by ring excitation control is easy especially for a single phase SRM or a force modulator based on a single phase SRM. FIG. 4j has shown 3 curved stream-line rotor poles/4 salient poles and FIG. 4k has shown 5 curved stream-line rotor poles/4 salient poles for reference. Obviously, the controls of FIG. 4j and FIG. 4k are more complicated than a single phase SRM or a force modulator based on a single phase SRM. The shape of curved stream-line rotor poles are not limited and the shape of each curved stream-line rotor pole can be different from that of another curved stream-line rotor pole of a same rotor.

A chamber is formed by the rotor cylinder, salient cylinder, and two rotor poles. If an area in the chamber normal to an axial air flow decreases, then an air pressure along the axial air flow will increase. This can be done by gradually enlarging the rotor cylinder, gradually papering off the rotor poles, or gradually enlarging the rotor cylinder and gradually tapering off the rotor poles. FIG. 4l has shown an embodiment of gradually tapered off rotor poles of the first type SRM. FIG. 4l has shown a gradually tapered off curved stream-line rotor pole 1332 and an arrow sign 4034 expresses an axial air flow. A first height 4033 of the rotor pole 1332 at a position A smaller than a second height 4032 of the rotor pole 1332 at a position B expresses the rotor pole gradually tapered off toward that direction. Obviously, an area of the chamber normal to the air flow 4034 gets smaller followed by the gradually tapered off rotor poles. And, a salient cylinder surrounding the rotor poles has to gradually taper off to conform the gradually tapered rotor poles.

FIG. 4m has shown an embodiment of gradually tapered off rotor poles of the second type SRM. A first height 4552 of a curved stream-line rotor pole 455 at a position A smaller than a second height 4551 of the rotor pole 455 at a position B expresses the rotor pole 455 gradually tapers toward that direction. FIG. 4m has shown an arrow 4553 to express an axial air flow. And, obviously, a salient cylinder surrounded by the rotor will conform accordingly.

An embodiment of a force modulator assembly is revealed. A force modulator assembly is formed by a plurality of force modulators having a common shaft. The plurality of force modulators have different rotor sizes from each other and have curved stream-line rotor poles. An air flows into a first force modulator through its air-in passageway and an air out of the first force modulator through its air-out passageway is an air in of a second force modulator through its air-in passageway and an air out of the second force modulator through its air-out passageway is an air in of a third force modulator through its air-in passageway and an air out of the third force modulator through its air-out passageway is an air in of a fourth force modulator through its air-in passageway, and so on. For the purpose of convenience, this air in and air out relations of the plurality of force modulators of the force modulator assembly is called air-in-air-out serial connection of the plurality of force modulators of the force modulator assembly.

An embodiment of a force modulator assembly having three first type force modulators is shown in FIG. 5b. The force modulator assembly is formed by three first type force modulators in different rotor sizes from each other respectively as a first force modulator 471, a second force modulator 472, and a third force modulator 473 having a common shaft 4123 fixed on the rotor of each force modulator.

Each force modulator has an air-in passageway, an air-out passageway, and an uni-direction compensating air-in passageway which has an one-way check valve for only allowing air to flow uni-direction into its chamber.

For example, the second force modulator 472 has an air-in passageway 4721, an air-out passageway 4722, and a compensating air-in passageway 4723 installed with an one-way check valve 47231 as discussed earlier. Each force modulator has curved stream-line rotor poles so that air into a chamber with the modulation by electrical power will be speeded vortically out of the chamber.

An air out of the first force modulator 471 through its air-out passageway is an air in of the second force modulator 472 through its air-in passageway as simply indicated by a first tube 478 and an air out of the second force modulator 472 through its air-out passageway is an air in of the third force modulator 473 through its air-in passageway as simply indicated by a second tube 479.

FIG. 5b has assumed the rotor size of the second force modulator 472 is the biggest among the three. When air out of the first force modulator 471 into the bigger size second force modulator 472, the air pressure acts on a bigger rotor so that the torque of the shaft 4123 increases, which means that the torque on the other two force modulators increases due to common shaft. The bigger shaft torque for each smaller rotor size force modulator gains more capability to push its air out into a next force modulator and at the same time suck in more air to increase the amount of air pushing the rotor pole of the next force modulator. Air driving a smaller rotor will gain faster rotating speed which will also be imposed on the other two force modulators due to common shaft. Power is the multiplication of torque and rotating speed so that a bigger power can be obtained. The force modulator assembly has characterized different rotor sizes for producing different torques and rotating speeds on a common shaft.

Seen in FIG. 5b, air into the first force modulator 471 through its air-in passageway 4711 will be accelerated all the way out of the third force modulator 473 through it air-out passageway 4732. And obviously, the force modulator assembly can be a very good air compressor and can deliver considerable torque power as well. The number of the force modulators of the force modulator assembly is not limited.

The performance of a force modulator assembly can be further improved and controllable if at least a pressured air source is disposed between two force modulators of the force modulator assembly. Based on FIG. 5b, FIG. 5m has shown a second pressured air source 474 and a third pressured air source 475 respectively connecting the first tube 478 and the second tube 479. Two one-way check valves 4742 and 4752 respectively installed on the first tube 478 and the second tube 479 express to stop the second pressured air source 474 and the third pressured air source 475 flowing into its previous force modulator. A first control valve 4741 and a second control valve 4751 indicating the second pressured air source 474 and the third pressured air source 475 are controllable, for example, they can be on/off or open/close switched or the flow rate flowing through them is controllable. The second pressured air source 474 and the third pressured air source 475 can help to further precisely control the output of the force modulator assembly.

A second air-in passageway can be installed in any one force modulator of the force modulator assembly functioning to slow down a rotating rotor to gain better controllability on the force modulator assembly. As shown in FIG. 5m, a second air-in passageway 4724 to the second force modulator 472 is seen. Assuming air out of the second air-in passageway 4724 of the second force modulator 472 pushes its rotor pole to rotate at a first orientation and air of the second air-in passageway 4724 of the second force modulator 472 to push its rotor pole to rotate at a second orientation. The first orientation is opposite to the second orientation so that air out of the second air-in passageway 4724 of the second force modulator 472 can function as brake to slow down the rotating shaft.

The present invention force modulator can be viewed as an air motor if no electrical driving on the force modulator. The present invention force modulator can be viewed as an improved SRM using curved stream-line poles of the rotor if no air driving on the force modulator.

We claim:

1. A force modulator, comprising:
an electric switched reluctance motor, comprising:
a coil-wound stator having a plurality of poles, having a salient cylinder, and having a stator cylinder;
a rotor having a plurality of poles and having a rotor cylinder, and
at least a bearing coupled between the stator and the rotor for sustaining a relative motion between the rotor and the stator, wherein a rotor-salient-cylinder space is formed between the salient cylinder of the stator and the rotor cylinder of the rotor, and the rotor-salient-cylinder space has a first open end and a second open end;
a first lid for covering the first open end of the rotor-salient-cylinder space;
a second lid for covering the second open end of the rotor-salient-cylinder space;
an air-tight bearing disposed between a gap between the salient cylinder and each pole of the rotor of the electric switched reluctance motor for air-tighting the gap;
a first air-in passageway having at least a hole opened on the salient cylinder and at least an opening outside the electric switched reluctance motor for air outside the electric switched reluctance motor flowing through the opening and the hole of the salient cylinder into the rotor-salient-cylinder space; and
a first air-out passageway having at least a hole opened on the salient cylinder and at least an opening outside the switched reluctance motor for air inside the rotor-salient-cylinder space flowing through the hole of the salient cylinder and the opening to outside the switched reluctance motor;
wherein
a chamber is formed between two neighboring poles of the rotor in the rotor-salient-cylinder space covered by the first lid and the second lid such that a plurality of chambers are formed in the rotor salient-cylinder space covered by the first lid and the second lid,
and an air flows through the first air-in passageway into a chamber to produce a pushing force on the pole of the rotor of the switched reluctance motor to make the rotor rotate at a first orientation and cool a heat produced in the electric switched reluctance motor,
and the air in the chamber is released through the first air-out passageway before the chamber takes a next air in through the first air-in passageway;
and the rotor rotates against the stator of the electric switched reluctance motor by the excitations of electrical power and air power.

2. The force modulator of claim 1, wherein the air-tight bearing comprising a plurality of slots built on a surface facing the salient cylinder of each pole of the rotor of the electric switched reluctance motor and a plurality of cylindrical rollers, and one cylindrical roller is disposed in each slot, and at least a portion of each cylindrical roller is disposed in its slot, and each cylindrical roller is confined between the salient cylinder and its slot for providing an air-tight in the gap between the salient cylinder and each pole of the rotor of the electric switched reluctance motor, and an orientation of a rotation of a cylindrical roller in each slot is in parallel to an orientation of a rotation of the rotor of the electric switched reluctance motor.

3. The force modulator of claim 2, further comprising a second air-in passageway having at least a hole opened on the salient cylinder and at least an opening outside the electric switched reluctance motor for air outside the electric switched reluctance motor flowing through the opening and the hole of the salient cylinder into the rotor-salient-cylinder space and a second air-out passageway having at least a hole opened on the salient cylinder and at least an opening outside the electric switched reluctance motor for air inside the rotor-salient-cylinder space flowing through the hole of the salient cylinder and the opening to outside the electric switched reluctance motor;
wherein an air flows through the second air-in passageway into a chamber to produce a pushing force on the pole of the rotor of the electric switched reluctance motor to make the rotor rotate at a second orientation and cool a heat produced in the electric switched reluctance motor, and the air in the chamber is released through the second air-out passageway before the chamber takes a next air in through the second air-in passageway, and the first orientation is opposite to the second orientation so that the rotor of the electric switched reluctance motor rotates counterclockwisely or clockwisely and air coming out through any one of the first air-in passageway and the second air-in passageway on the poles of the rotor of the electric switched reluctance motor functions to slow down a rotation of the rotor of the electric switched reluctance motor pushed by air coming out through the other one of the first air-in passageway and the second air-in passageway.

4. The force modulator of claim 3, wherein the first air-out passageway is the second air-out passageway.

5. The force modulator of claim 1, further comprising a compensating air passageway having at least a hole opened on the salient cylinder and at least an air-in opening outside the switched reluctance motor and at least an one-way check valve installed with each air-in opening of the compensating air passageway, wherein the compensating air passageway only allows air to flow unidirection into the chamber.

6. The force modulator of claim 2, further comprising a compensating air passageway having at least a hole opened on the salient cylinder and at least an air-in opening outside the switched reluctance motor and at least an one-way check valve installed with each air-in opening of the compensating air passageway, wherein the compensating air passageway only allows air to flow unidirection into the chamber.

7. The force modulator of claim 3, further comprising a compensating air passageway having at least a hole opened on the salient cylinder and at least an air-in opening outside the switched reluctance motor and at least an one-way check valve installed with each air-in opening of the compensating air passageway, wherein the compensating air passageway only allows air to flow unidirection into the chamber.

8. The force modulator of claim 4, further comprising a compensating air passageway having at least a hole opened on the salient cylinder and at least an air-in opening outside the switched reluctance motor and at least an one-way check valve installed with each air-in opening of the compensating air passageway, wherein the compensating air passageway only allows air to flow unidirection into the chamber.

9. The force modulator of claim 2, wherein a significant air pressure is built in a chamber between an air flowing through the first air-in passageway into the chamber and the air flowing through the first air-out passageway out of the chamber, and the air pressure built in the chamber is transformed into a rotating power of the rotor of the electric switched reluctance motor.

10. The force modulator of claim 8, wherein a significant air pressure is built in a chamber between an air flowing through the first air-in passageway into the chamber and the air flowing through the first air-out passageway out of the chamber, and the air pressure in the chamber is transformed into a rotating power of the rotor of the electric switched reluctance motor.

11. The force modulator of claim 1, wherein the poles of the rotor of the electric switched reluctance motor are curved stream-line, and each curved stream-line pole of the rotor is for producing a velocity triangle having an axial air flow component normal to an orientation of the rotation of the rotor of the electric switched reluctance motor.

12. The force modulator of claim 11, wherein the air-tight bearing comprising a plurality of slots built on a surface facing the salient cylinder of each pole of the rotor of the electric switched reluctance motor and a plurality of cylindrical rollers, and one cylindrical roller is disposed in each slot, and at least a portion of each cylindrical roller is disposed in its slot, and each cylindrical roller is confined between the salient cylinder and its slot for providing an air-tight in the gap between the salient cylinder and each pole of the rotor of the electric switched reluctance motor, and an orientation of a rotation of a cylindrical roller in each slot is in parallel to an orientation of a rotation of the rotor of the electric switched reluctance motor.

13. The force modulator of claim 12, further comprising a second air-in passageway having at least a hole opened on the salient cylinder and at least an opening outside the electric switched reluctance motor for air outside the electric switched reluctance motor flowing through the opening and the hole of the salient cylinder into the rotor-salient-cylinder space and a second air-out passageway having at least a hole opened on the salient cylinder and at least an opening outside the electric switched reluctance motor for air inside the rotor-salient-cylinder space flowing through the hole of the salient cylinder and the opening to outside the electric switched reluctance motor;
wherein an air flows through the second air-in passageway into a chamber to produce a pushing force on the pole of the rotor of the electric switched reluctance motor to make the rotor rotate at a second orientation and cool a heat produced in the electric switched reluctance motor, and the air in the chamber is released through the second air-out passageway before the chamber takes a next air in through the second air-in passageway, and the first orientation is opposite to the second orientation so that the rotor of the electric switched reluctance motor rotates counterclockwisely or clockwisely and air coming out through any one of the first air-in passageway and the second air-in passageway on the poles of the rotor of the electric switched reluctance motor functions to slow down a rotation of the rotor of the electric switched reluctance motor pushed by air coming out through the other one of the first air-in passageway and the second air-in passageway.

14. The force modulator of claim 13, wherein the first air-out passageway is the second air-out passageway.

15. The force modulator of claim 11, further comprising a compensating air passageway having at least a hole opened on the salient cylinder and at least an air-in opening outside the switched reluctance motor and at least an one-way check valve installed with each air-in opening of the compensating air passageway, wherein the compensating air passageway only allows air to flow unidirection into the chamber.

16. The force modulator of claim 12, further comprising a compensating air passageway having at least a hole opened on the salient cylinder and at least an air-in opening outside the switched reluctance motor and at least an one-way check valve installed with each air-in opening of the compensating air passageway, wherein the compensating air passageway only allows air to flow unidirection into the chamber.

17. The force modulator of claim 13, further comprising a compensating air passageway having at least a hole opened on the salient cylinder and at least an air-in opening outside the switched reluctance motor and at least an one-way check valve installed with each air-in opening of the compensating air passageway, wherein the compensating air passageway only allows air to flow unidirection into the chamber.

18. The force modulator of claim 14, further comprising a compensating air passageway having at least a hole opened on the salient cylinder and at least an air-in opening outside the switched reluctance motor and at least an one-way check valve installed with each air-in opening of the compensating air passageway, wherein the compensating air passageway only allows air to flow unidirection into the chamber.

19. The force modulator of claim 11, wherein a length of each of at least a portion of the plurality of cylindrical rollers is shorter than a length of the pole of the rotor of the electric switched reluctance motor so that a space exists between two cylindrical rollers, and a third cylindrical roller blocks a space between a first cylindrical roller and a second cylindrical roller to make an air detouring flowing through the space for improving air-tight in the gap between the salient cylinder and each pole of the rotor of the electric switched reluctance motor, and the first air-in passageway is a first type air passageway, a second type air passageway, a third type air passageway, or any combinations of the first type air passageway, the second type air passageway, and the third type air passageway, and the first air-out passageway is the first type air passageway, the second type air passageway, the third type air passageway, or any combinations of the first type air passageway, the second type air passageway, and the third type air passageway, and a space between the salient cylinder and the stator cylinder is filled by a harden matter to strengthen a support to the salient cylinder and strengthen a hold to the first air-in passageway and the first air-out passageway.

20. The force modulator of claim 12, wherein a length of each of at least a portion of the plurality of cylindrical rollers is shorter than a length of the pole of the rotor of the electric switched reluctance motor so that a space exists between two cylindrical rollers, and a third cylindrical roller blocks a space between a first cylindrical roller and a second cylindrical roller to make an air detouring flowing through the space for improving air-tight in the gap between the salient cylinder and each pole of the rotor of the electric switched reluctance motor, and the first air-in passageway is a first type air passageway, a second type air passageway, a third type air passageway, or any combinations of the first type air passageway, the second type air passageway, and the third type air passageway, and the first air-out passageway is the first type air passageway, the second type air passageway, the third type air passageway, or any combinations of the first type air passageway, the second type air passageway, and the third type air passageway, and a space between the salient cylinder and the stator cylinder is filled by a harden matter to strengthen a support to the salient cylinder and strengthen a hold to the first air-in passageway and the first air-out passageway.

21. The force modulator of claim 14, wherein a length of each of at least a portion of the plurality of cylindrical rollers is shorter than a length of the pole of the rotor of the electric switched reluctance motor so that a space exists between two cylindrical rollers, and a third cylindrical roller blocks a space between a first cylindrical roller and a second cylindrical roller to make an air detouring flowing through the space for improving air-tight in the gap between the salient cylinder and each pole of the rotor of the electric switched reluctance motor, and the first air-in passageway is a first type air passageway, a second type air passageway, a third type air passageway, or any combinations of the first type air passageway, the second type air passageway, and the third type air passageway, and the first air-out passageway is the first type air passageway, the second type air passageway, the third type air passageway, or any combinations of the first type air passageway, the second type air passageway, and the third type air passageway, and a space between the salient cylinder and the stator cylinder is filled by a harden matter to strengthen a support to the salient cylinder and strengthen a hold to the first air-in passageway, the second air-in passageway, and the first air-out passageway.

22. The force modulator of claim 18, wherein a length of each of at least a portion of the plurality of cylindrical rollers is shorter than a length of the pole of the rotor of the switched reluctance motor so that a space exists between two cylindrical rollers, and a third cylindrical roller blocks a space between a first cylindrical roller and a second cylindrical roller to make an air detouring flowing through the space for improving air sealing in the gap between the salient cylinder and the poles of the rotor of the switched reluctance motor, and the first air-in passageway is a first type air passageway, a second type air passageway, a third type air passageway, or any combinations of the first type air passageway, the second type air passageway, and the third type air passageway, and the first air-out passageway is the first type air passageway, the second type air passageway, the third type air passageway, or any combinations of the first type air passageway, the second type air passageway, and the third type air passageway, and a space between the salient cylinder and the stator cylinder is filled by a harden matter to strengthen a support to the salient cylinder and strengthen a hold to the first air-in passageway, the second air-in passageway, and the first air-out passageway.

23. The force modulator of claim 22, further comprising a shaft fixed through both sides of the rotor or the stator of the electric switched reluctance motor, a first cover, and a second cover,
wherein the first lid and the second lid are respectively a first thrust bearing and a second thrust bearing respectively mounted with the shaft, and a first bearing and a second bearing respectively mounted on the shaft at the both sides of the rotor or the stator of the electric switched reluctance motor, and the first cover and the second cover respectively cover the first thrust bearing and the second thrust bearing, and the first cover and the second cover respectively connect to the first bearing and the second bearing mounted on the shaft.

24. The force modulator of claim 23, wherein a number of the poles of the stator and a number of the poles of the rotor are equal, and excitations of the poles of the stator on the poles of the rotor are ring-by-ring excitations.

25. The force modulator of claim 23, wherein a stator-salient-cylinder space formed between the salient cylinder and the stator cylinder has a first open end and a second open end, and the shaft fixed through both sides of the rotor,
and the first air-in passageway, the second air-in passageway and the compensating air passageway are respectively formed by a second type hollow tube disposed in the stator-salient-cylinder space between the salient cylinder and the stator cylinder respectively having an air-in entrance at either the first open end or the second open end of the stator-salient-cylinder space and a plurality of third type hollow tubes with each third type hollow tube having a hole opened on the salient cylinder, and the second type hollow tube connects the plurality of third type hollow tubes so that air can flow into the air entrance of the second type hollow tube, the third type hollow tubes, and the holes opened on the salient cylinder into the rotor-salient-cylinder space,
and the holes opened on the salient cylinder respectively of the first air-in passageway, the second air-in passageway and the compensating air passageway are in a row parallel to an axial orientation of the stator cylinder,
and the first air-out passageway is formed by a second type hollow tube disposed in the stator-salient-cylinder space formed between the salient cylinder and the stator cylinder having an air-out exit at either the first open end or the second open end of the stator-salient-cylinder space and a third type hollow tube having a hole opened on the salient cylinder, and the second hollow tube connects the plurality of third tubes so that air inside the rotor-salient-cylinder space flows through the hole opened on the salient cylinder, the third type hollow tube, and the second type hollow tube out of the electric switched reluctance motor,
and the first air-in passageway, the second air-in passageway, and the first air-out passageway are such disposed that at any time a chamber doesn't bestride the first air-in passageway, the second air-in passageway, and the first air-out passageway to avoid air into a chamber through the first air-in passageway or the second air-in passageway being immediately released through the first air-out passageway out so that a significant air pressure can be built in the chamber and lasts for a period of time, and the air pressure is transformed into a rotating power of the rotor of the electric switched reluctance motor.

26. The force modulator of claim 23, wherein a stator-salient-cylinder space formed between the salient cylinder and the stator cylinder has a first open end and a second open end, and the shaft fixed through both sides of the stator,
and the first air-in passageway, the second air-in passageway and the compensating air passageway are respectively formed by a second type hollow tube disposed in the stator-salient-cylinder space between the salient cylinder and the stator cylinder, a plurality of third type hollow tubes with each third type hollow tube having a hole opened on the salient cylinder, a first type hollow tube penetrating the stator, and a first type hollow tube extension going through the shaft out, and the second hollow tube connects the plurality of third type tubes and the first type hollow tube that connects the first type hollow tube extension so that air can flow into the first type hollow tube extension, the first type hollow tube, the second type hollow tube, and the third type hollow tubes, and the holes on the salient cylinder into the rotor-salient-cylinder space,
and the holes opened on the salient cylinder respectively of the first air-in passageway, the second air-in passageway and the compensating air passageway are in a row parallel to an axial orientation of the stator cylinder,
and the first air-out passageway is formed by a second type hollow tube disposed in the stator-salient-cylinder space between the salient cylinder and the stator cylinder, a third type hollow tube having a hole opened on the salient cylinder, a first type hollow tube penetrating the stator, and a first type hollow tube extension going through the shaft out, and the second hollow tube connects the third type tube and the first type hollow tube that connects the first type hollow tube extension so that air in the rotor-salient-cylinder space can flow through the holes on the salient cylinder, the third type hollow tube, the second type hollow tube, the first type hollow tube, and the first type hollow tube extension going through the shaft out of the electric switched reluctance motor,
and the first air-in passageway, the second air-in passageway, and the first air-out passageway are such disposed that at any time a chamber doesn't bestride the first air-in passageway, the second air-in passageway, and the first air-out passageway to avoid air into a chamber through the first air-in passageway or the second air-in passageway being immediately released through the first air-out passageway out so that a significant air pressure can be built in the chamber and lasts for a period of time, and the air pressure is transformed into a rotating power of the rotor of the electric switched reluctance motor.

27. A force modulator assembly comprising a plurality of force modulators each force modulator comprising:
an electric switched reluctance motor, comprising:
a coil-wound stator having a plurality of poles, having a salient cylinder, and having a stator cylinder;
a rotor having a plurality of curved stream-line poles, having a rotor cylinder, and having a rotor size, wherein a rotor-salient-cylinder space is formed between the salient cylinder of the stator and the rotor cylinder of the rotor, and the rotor-salient-cylinder space has a first open end and a second open end;
a shaft connected through the rotor or the stator,
a first thrust bearing mounted with the shaft for covering the first open end of the rotor-salient-cylinder space;
a second thrust bearing mounted with the shaft for covering the second open end of the rotor-salient-cylinder space;
a first bearing mounted on the shaft at the first thrust bearing side for sustaining a relative motion between the rotor and the stator,
a second bearing mounted on the shaft at the second thrust bearing side for sustaining a relative motion between the rotor and the stator,
a first cover connected to the first bearing and covering the first thrust bearing,
a second cover connected to the second bearing and covering the second thrust bearing,
an air-tight bearing disposed between a gap between the salient cylinder and each pole of the rotor of the electric switched reluctance motor for air-tighting the gap,
a first air-in passageway having at least a hole opened on the salient cylinder and at least an air-in entrance outside the electric switched reluctance motor for air outside the electric switched reluctance motor flowing through the air-in entrance and the hole of the salient cylinder into the rotor-salient-cylinder space;
a first air-out passageway having at least a hole opened on the salient cylinder and at least an air-out exit outside the electric switched reluctance motor for air inside the rotor-salient-cylinder space flowing through the hole of the salient cylinder and the air-out exit to outside the electric switched reluctance motor;
wherein
a chamber is formed between two neighboring curved stream-line poles of the rotor in the rotor-salient-cylinder space covered by the first thrust bearing and the second thrust bearing such that a plurality of chambers are formed in the rotor-salient-cylinder space covered by the first thrust bearing and the second thrust bearing, and an air flows through the first air-in passageway into a chamber to produce a pushing force on the pole of the rotor of the electric switched reluctance motor to make the rotor rotate at a first orientation and cool a heat produced in the electric switched reluctance motor,
and the air in the chamber is released through the first air-out passageway before the chamber takes a next air in through the first air-in passageway;
and the rotor rotates against the stator of the electric switched reluctance motor by the excitations of electrical power and air power,
and the plurality of force modulators have a common shaft, and the plurality of force modulators are in air-in-air-out serial connection, and rotor sizes of the plurality of force modulators are different from each other for producing different rotor torques and rotating speeds on the common shaft.

28. The force modulator of claim 27, wherein the air-tight bearing comprising a plurality of slots built on a surface facing the salient cylinder of each pole of the rotor of the electric switched reluctance motor and a plurality of cylindrical rollers, and one cylindrical roller is disposed in each slot, and at least a portion of each cylindrical roller is disposed in its slot, and each cylindrical roller is confined between the salient cylinder and its associated slot for providing an air-tight in the gap between the salient cylinder and each pole of the rotor of the electric switched reluctance motor, and an orientation of a rotation of a cylindrical roller in each slot is in parallel to an orientation of a rotation of the rotor of the electric switched reluctance motor.

29. The force modulator assembly of claim 28, at least a force modulator of the plurality of force modulators further comprising a second air-in passageway having at least a hole opened on the salient cylinder and at least an air-in entrance outside the electric switched reluctance motor for air outside the electric switched reluctance motor flowing through the air-in entrance and the hole of the salient cylinder into the rotor-salient-cylinder space,
wherein an air flows through the second air-in passageway into a chamber to produce a pushing force on the pole of the rotor of the electric switched reluctance motor to make the rotor rotate at a second orientation and cool a heat produced in the electric switched reluctance motor, and the air in the chamber is released through the first air-out passageway before the chamber takes a next air in through the second air-in passageway, and the first orientation is opposite to the second orientation so that air into the second air-in passageway functions to slow down a rotating shaft.

30. The force modulator assembly of claim 28, each force modulator further comprising a compensating air passageway having at least a hole opened on the salient cylinder and at least an air-in opening outside the switched reluctance motor and at least an one-way check valve installed with each air-in opening of the compensating air passageway, wherein the compensating air passageway only allows air to flow unidirection into the chamber.

31. The force modulator assembly of claim 29, each force modulator further comprising a compensating air passageway having at least a hole opened on the salient cylinder and at least an air-in opening outside the switched reluctance motor and at least an one-way check valve installed with each air-in opening of the compensating air passageway, wherein the compensating air passageway only allows air to flow unidirection into the chamber.

32. The force modulator assembly of claim 28, wherein a significant air pressure is built in a chamber between an air flowing through the first air-in passageway into the chamber and the air flowing through the first air-out passageway out of the chamber of each force modulator, and the air pressure built in the chamber is transformed into a rotating power of the rotor of the switched reluctance motor,
and a length of each of the plurality of cylindrical rollers is shorter than a length of the pole of the rotor of each force modulator so that a space exists between two cylindrical rollers, and a third cylindrical roller blocks a space between a first cylindrical roller and a second cylindrical roller to make an air detouring flowing through the space for improving air-tighting in the gap between the salient cylinder and each pole of the rotor of the electric switched reluctance motor,
and the first air-in passageway of each force modulator is a first type air passageway, a second type air passageway, a third type air passageway, or any combinations of the first type air passageway, the second type air passageway, and the third type air passageway, and the first air-out passageway of each force modulator is the first type air passageway, the second type air passageway, the third type air passageway, or any combinations of the first type air passageway, the second type air passageway, and the third type air passageway, and a space between the salient cylinder and the stator cylinder of each force modulator is filled by a harden matter to strengthen a support to the salient cylinder and strengthen a hold to the first air-in passageway and the first air-out passageway.

33. The force modulator assembly of claim 29, wherein a significant air pressure is built in a chamber between an air flowing through the first air-in passageway into the chamber and the air flowing through the first air-out passageway out of the chamber of each force modulator, and the air pressure built in the chamber is transformed into a rotating power of the rotor of the switched reluctance motor,
and a length of each of the plurality of cylindrical rollers is shorter than a length of the pole of the rotor of each force modulator so that a space exists between two cylindrical rollers, and a third cylindrical roller blocks a space between a first cylindrical roller and a second cylindrical roller to make an air detouring flowing through the space for improving air-tighting in the gap between the salient cylinder and each pole of the rotor of the electric switched reluctance motor,
and the first air-in passageway of each force modulator is a first type air passageway, a second type air passageway, a third type air passageway, or any combinations of the first type air passageway, the second type air passageway, and the third type air passageway, and the first air-out passageway of each force modulator is the first type air passageway, the second type air passageway, the third type air passageway, or any combinations of the first type air passageway, the second type air passageway, and the third type air passageway, and a space between the salient cylinder and the stator cylinder of each force modulator is filled by a harden matter to strengthen a support to the salient cylinder and strengthen a hold to the first air-in passageway, the second air-in passageway, and the first air-out passageway.

34. The force modulator assembly of claim 30, wherein a significant air pressure is built in a chamber between an air flowing through the first air-in passageway into the chamber and the air flowing through the first air-out passageway out of the chamber of each force modulator, and the air pressure built in the chamber is transformed into a rotating power of the rotor of the switched reluctance motor,
and a length of each of the plurality of cylindrical rollers is shorter than a length of the pole of the rotor of each force modulator so that a space exists between two cylindrical rollers, and a third cylindrical roller blocks a space between a first cylindrical roller and a second cylindrical roller to make an air detouring flowing through the space for improving air-tighting in the gap between the salient cylinder and each pole of the rotor of the electric switched reluctance motor,
and the first air-in passageway of each force modulator is a first type air passageway, a second type air passageway, a third type air passageway, or any combinations of the first type air passageway, the second type air passageway, and the third type air passageway, and the first air-out passageway of each force modulator is the first type air passageway, the second type air passageway, the third type air passageway, or any combinations of the first type air passageway, the second type air passageway, and the third type air passageway, and a space between the salient cylinder and the stator cylinder of each force modulator is filled by a harden matter to strengthen a support to the salient cylinder and strengthen a hold to the first air-in passageway, the first air-out passageway, and the compensating air passageway.

35. The force modulator assembly of claim 31, wherein a significant air pressure is built in a chamber between an air flowing through the first air-in passageway into the chamber and the air flowing through the first air-out passageway out of the chamber of each force modulator, and the air pressure built in the chamber is transformed into a rotating power of the rotor of the switched reluctance motor,
and a length of each of the plurality of cylindrical rollers is shorter than a length of the pole of the rotor of each force modulator so that a space exists between two cylindrical rollers, and a third cylindrical roller blocks a space between a first cylindrical roller and a second cylindrical roller to make an air detouring flowing through the space for improving air-tighting in the gap between the salient cylinder and each pole of the rotor of the electric switched reluctance motor,
and the first air-in passageway of each force modulator is a first type air passageway, a second type air passageway, a third type air passageway, or any combinations of the first type air passageway, the second type air passageway, and the third type air passageway, and the first air-out passageway of each force modulator is the first type air passageway, the second type air passageway, the third type air passageway, or any combinations of the first type air passageway, the second type air passageway, and the third type air passageway, and a space between the salient cylinder and the stator cylinder of each force modulator is filled by a harden matter to strengthen a support to the salient cylinder and strengthen a hold to the first air-in passageway, the second air-in passageway, the first air-out passageway, and the compensating air passageway.

36. The force modulator assembly of claim 35, wherein a stator-salient-cylinder space formed between the salient cylinder and the stator cylinder has a first open end and a second open end, and the shaft fixed through both sides of the rotor,
and the first air-in passageway, the second air-in passageway and the compensating air passageway are respectively formed by a second type hollow tube disposed in the stator-salient-cylinder space between the salient cylinder and the stator cylinder respectively having an air-in entrance at either the first open end or the second open end of the stator-salient-cylinder space and a plurality of third type hollow tubes with each third type hollow tube having a hole opened on the salient cylinder, and the second type hollow tube connects the plurality of third type hollow tubes so that air can flow into the air entrance of the second type hollow tube, the third type hollow tubes, and the holes opened on the salient cylinder into the rotor-salient-cylinder space,
and the holes opened on the salient cylinder respectively of the first air-in passageway, the second air-in passageway and the compensating air passageway are in a row parallel to an axial orientation of the stator cylinder,
and the first air-out passageway is formed by a second type hollow tube disposed in the stator-salient-cylinder space formed between the salient cylinder and the stator cylinder having an air-out exit at either the first open end or the second open end of the stator-salient-cylinder space and a third type hollow tube having a hole opened on the salient cylinder, and the second hollow tube connects the plurality of third tubes so that air inside the rotor-salient-cylinder space flows through the hole opened on the salient cylinder, the third type hollow tube, and the second type hollow tube out of the electric switched reluctance motor,
and the first air-in passageway, the second air-in passageway, and the first air-out passageway are such disposed that at any time a chamber doesn't bestride the first air-in passageway, the second air-in passageway, and the first air-out passageway to avoid air into a chamber through the first air-in passageway or the second air-in passageway being immediately released through the first air-out passageway out so that a significant air pressure can be built in the chamber and lasts for a period of time, and the air pressure is transformed into a rotating power of the rotor of the electric switched reluctance motor.

37. The force modulator assembly of claim 36, further comprising at least a pressured air source, an one-way check valve, and a control valve, wherein the pressured air source connects between an air-out of a m^{th} force modulator and an air-in of a m+1^{th} force modulator as a pressured air source into the m+1^{th} force modulator, and the one-way check valve is disposed between the air-out of a m^{th} force modulator and the air-in of a m+1^{th} force modulator for stopping the air from the pressured air source from flowing into the m^{th} force modulator so that air out from the pressured air source only flows into the m+1^{th} force modulator, and the control valve control is for controlling the pressured air source, and the cylindrical rollers are made of magnetic material, and a number of the poles of the rotor and a number of the poles of the stator are equal.

38. A method to form a salient cylinder and air passageways of a force modulator comprising steps of:
(1) preparing a first type hollow tube if has any, a second type hollow tube, and a third type hollow tube, a coil-wound stator of a first type SRM, at least a hole penetrating through the stator if needed, and a tube-support device having at least a hole,
(2) connecting the second type hollow tube with the third type hollow tube that positions through the hole of the tube-support device disposed outside the stator,
(3) disposing the tube-support device after the step (2) into the stator,
(4) inserting the first type tube through the hole of the stator and then either through the hole of the tube-support device or connecting the second type tube,
(5) filling a matter having flowability into a space between the stator and the tube-support device,
(6) hardening the matter,
(7) cutting off the un-wanted hardened matter and the unwanted hollow tubes to form the salient cylinder and the hole opened on the salient cylinder, and
(8) coating the surface of salient cylinder with a wear-resisting material such as diamond-like material. Please note that if no hole penetrating through the stator, then a first type hollow tube is not needed and step (4) is skipped.
or
(1) preparing a coil-wound stator of a second type SRM having at least one stator hole therethrough, at least a first type hollow tube penetrating through the stator, at least a first type extension hollow tube, at least a second type hollow tube disposed in the “stator-salient-cylinder space” formed between the stator cylinder and the salient cylinder, at least a third type hollow tube having a hole opened on the salient cylinder, and a tube-support device having at least one hole,
(2) connecting the second type hollow tube with the first type hollow tube that connects the first type extension hollow tube through the stator hole of the stator,
(3) disposing the coil-wound stator after the step (2) inside the tube-support device,
(4) inserting the third type tube through the hole of the tube-support device to connect the second type tube disposed between the salient cylinder and the stator cylinder,
(5) filling a matter having flowability such as a form of liquid into a space between the stator and the tube-support device,
(6) hardening the matter,
(7) cutting off the un-wanted hardened matter and the unwanted hollow tubes to form the salient cylinder, and
(8) coating the surface of salient cylinder with a wear-resisting material such as diamond-like material.
